(19) United States
(12) Patent Application Publication
(10) Pub. No.: US 2019/0156715 A1
(43) Pub. Date: May 23, 2019

(54) METHOD AND SYSTEM FOR FACILITATING PROVISIONING OF HOLOGRAPHIC CONTENT

(71) Applicant: Pierce Elliott James, Lynnfield, MA (US)

(72) Inventor: Pierce Elliott James, Lynnfield, MA (US)

(21) Appl. No.: 16/250,788

(22) Filed: Jan. 17, 2019

Related U.S. Application Data
(63) Continuation-in-part of application No. 15/964,488, filed on Apr. 27, 2018.
(60) Provisional application No. 62/530,715, filed on Jul. 10, 2017.

(51) Int. Cl. G09G 3/00; G06F 3/01; G06F 3/147; G06F 21/32

(52) U.S. Cl. CPC G09G 3/003; G06F 3/017; G06F 3/147; G09G 2370/04; G09G 2354/00; G09G 2358/00; G06F 21/32

(57) ABSTRACT

Disclosed is a wearable display device configured to facilitate provisioning of holographic content in cooperation with at least one computing device. The wearable display device may include at least one sensor configured to detect sensor data corresponding to one or more of a location and an orientation of the wearable display device. Further, the location may include a geo-spatial location. Further, the wearable display device may include a communication interface configured to transmit the sensor data to the at least one computing device. Further, the communication interface may be configured to receive holographic projection content from the at least one computing device. Further, the wearable display device may include a processor configured to process the holographic projection content. Further, the wearable display device may include a display device configured to generate a visual display of the holographic projection content.

The current application is a continuation-in-part (CIP) application of a U.S. non-provisional application Ser. No. 15/964,488 filed on Apr. 27, 2018. The U.S. non-provisional application Ser. No. 15/964,488 claims a priority to a U.S. provisional application Ser. No. 62/530,715 filed on Jul. 10, 2017.

### FIELD OF THE INVENTION

The present invention relates generally to augmented reality, in particular, the present invention relates to a method and a system of facilitating provisioning of holographic content on a wearable display device.

### BACKGROUND OF THE INVENTION

Augmented reality (AR) technologies are gaining popularity with users across the world. These technologies aim to provide new user experiences to users to augment their life and entertainment.

However, AR devices are often quite complex and costly. The conventional AR devices often employ specialized wearable glasses. These devices performing multiple functions including tracking the location and orientation of the user, performing all the processing, and then displaying the images to the user based on the location and orientation of the user.

Accordingly, there is a need for improved systems and methods of facilitating provisioning of holographic content on a wearable display device that may also overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a wearable display device configured to facilitate provisioning of holographic content in cooperation with at least one computing device. The wearable display device may include at least one sensor configured to detect sensor data corresponding to one or more of a location and an orientation of the wearable display device. Further, the location may include a geo-spatial location. Further, the wearable display device may include a communication interface configured to transmit the sensor data to the at least one computing device. Further, the communication interface may be configured to receive holographic projection content from the at least one computing device. Further, the holographic projection content may be generated by the at least one computing device based on the sensor data. Further, the wearable display device may include a processor communicatively coupled to the communication interface. Further, the processor may be configured to process the holographic projection content. Further, the wearable display device may include a display device communicatively coupled to the processor. Further, the display device may be configured to generate a visual display of the holographic projection content.

According to some embodiments, the wearable display device may further include at least one sound producing device configured for generating sound based on audio content associated with the holographic projection content. Further, the at least one sound producing device may be communicatively coupled to the processor. Further, the communication interface may be configured to receive the audio content from the at least one computing device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flowchart of a method to provide an interactive augmented reality experience in accordance with some embodiments.

FIG. 2 is a flowchart of a method for initiating the registration phase for providing the interactive augmented reality experience in accordance with some embodiments.

FIG. 3 is a flowchart of a method for initiating the operation phase for providing the interactive augmented reality experience in accordance with some embodiments.

FIG. 4 is a flowchart of a method for initiating the programmable phase for providing the interactive augmented reality experience in accordance with some embodiments.

FIG. 5 is a flowchart of a method for initiating the shared operation phase for providing the interactive augmented reality experience in accordance with some embodiments.

FIG. 6 is a flowchart of a method for initiating the market phase for providing the interactive augmented reality experience in accordance with some embodiments.

FIG. 7 illustrates a system for providing the interactive augmented reality experience in accordance with some embodiments.

FIG. 8 is an illustration of a platform consistent with various embodiments of the present disclosure.

FIG. 9 is a block diagram of a wearable display device configured to facilitate provisioning of holographic content in cooperation with one or more computing devices in accordance with some embodiments.

FIG. 10 illustrates a visual display of the holographic projection content in accordance with an exemplary embodiment.

FIG. 11 is a block diagram of a computing device configured to facilitate provisioning of holographic content in cooperation with one or more wearable display devices, in accordance with some embodiments.

FIG. 12 illustrates a block diagram representation of a wearable display device that may be configured to project and/or customize a holographic projection content based on one or more characteristics of a user, in accordance with some embodiments.

FIG. 13 illustrates a block diagram representation of a wearable display device that may be configured to provide a holographic projection content to a user in a way such that the holographic projection content may seem clear and/or focused to the user that may be having impaired eyes, in accordance with some embodiments.

FIG. 14 illustrates a block diagram representation of a wearable display device that may be configured to adjust a visual parameter associated with a holographic projection content based on a surrounding of the wearable display device, in accordance with some embodiments.

FIG. 15 illustrates a block diagram representation of a wearable display device that may be configured to adjust the visual parameter associated with the holographic projection content based on an indicating signal from a user, in accordance with some embodiments.

FIG. 16 illustrates a block diagram representation of a wearable display device that may be configured to allow a user to create a three-dimensional animation from a market user interface, in accordance with some embodiments.

FIG. 17 illustrates a block diagram representation of the wearable display device that may be configured to allow a user to geo-drop a three-dimensional animation at a geo-location on a map, in accordance with some embodiments.

FIG. 18 illustrates a block diagram representation of a wearable display device that may be configured to allow only an authorized user to geo-drop the three-dimensional animation at the geo-location, in accordance with some embodiments.

FIG. 19 illustrates a block diagram representation of a wearable display device that may be configured to allow the user to geo-drop the three-dimensional animation at the geo-location based on a location of the user, in accordance with some embodiments.

FIG. 20 illustrates an exemplary computing system that may be employed to implement processing functionality for various embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of augmented reality, embodiments of the present disclosure are not limited to use only in this context.

Overview

The present disclosure relates to an application and method thereof that enables an interactive augmented reality experience that utilizes a conventional computing device and an extraneous display device such as a screen equipped pair of glasses, wherein the user's proximity and orientation to the computing device reflects the display of a holotag projection.

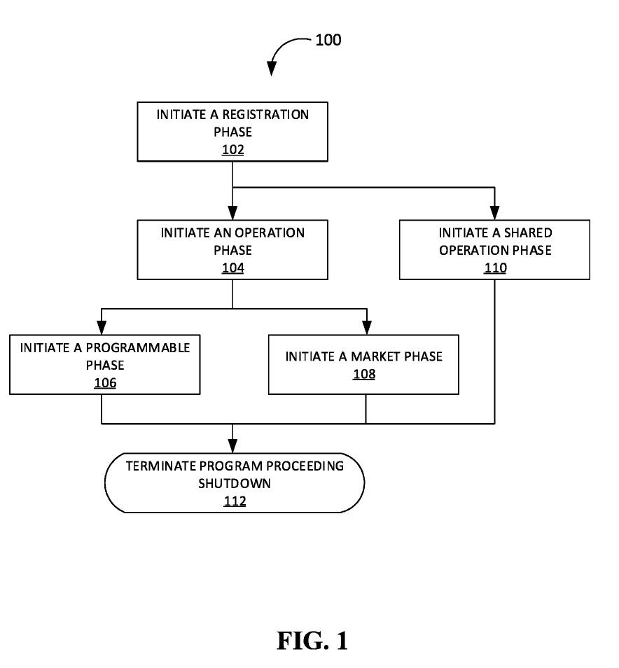

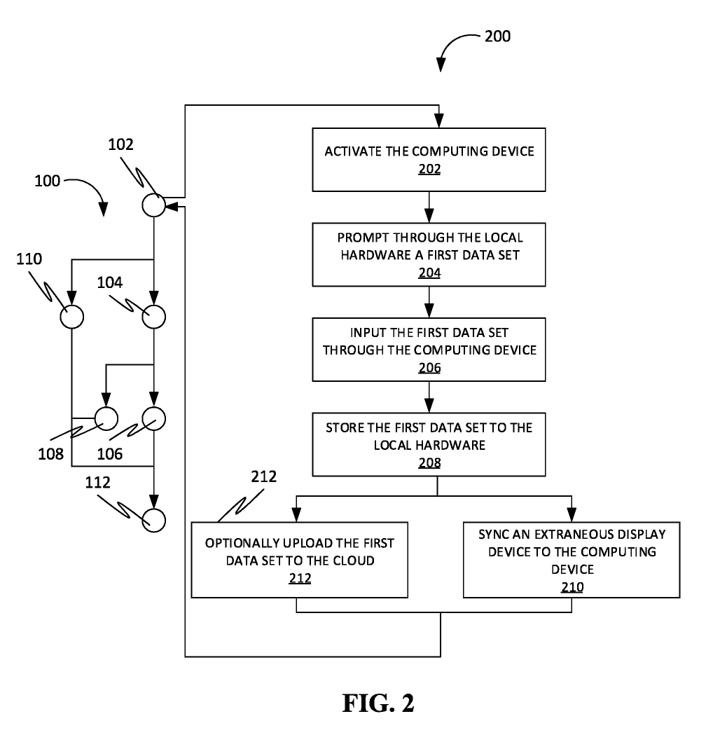

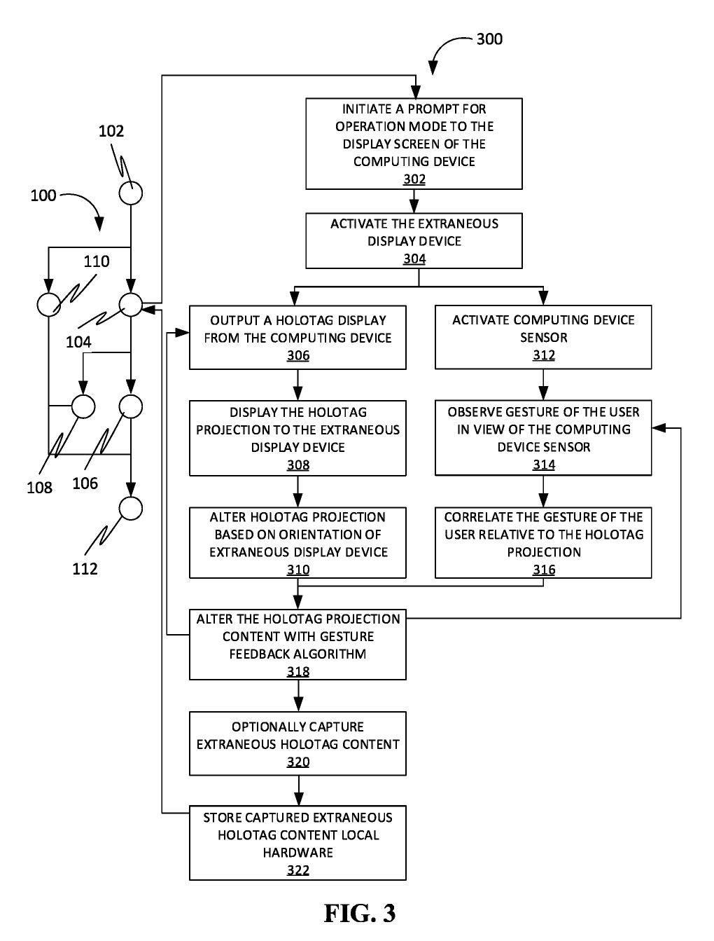

FIG. 1 is a flowchart of a method 100 to provide an interactive augmented reality experience in accordance with some embodiments. The method 100 includes initiating the registration phase at 102, initiating an operation phase at 104, and initiating a programmable phase at 106. The registration phase is explained in further detail in conjunction with FIG. 2 below. The operation phase is explained in further detail in conjunction with FIG. 3 below. Further, when the operation phase concludes, a user may be given an opportunity to enter the programmable phase (at 106) or a market phase at 108. Further, after the conclusion of the registration phase, the user may elect to enter an operation phase where they alone are party to the application, or initiating a shared operation phase (at 110) where the user may broadcast holotag projection content to one or more additional users and/or use one or more computing devices and sensors. At 112, the program may be terminated when the user initiates the shutdown.

FIG. 2 is a flowchart of a method 200 for initiating the registration phase for providing the interactive augmented reality experience in accordance with some embodiments. The method 200 may include activating a computing device at 202, prompting through the local hardware a first data set at 204, inputting the first data set through the computing device at 206, storing the first data set to the local hardware at 208, and subsequently the latter may be proceeded by a simultaneous pair of steps that includes syncing an extraneous display device to the computing device at 210, and optionally uploading the first data set to the cloud at 212. The registration phase relates to establishing the user identity uniquely to the computing device, syncing their extraneous display device, and optionally registering the user to a cloud or internet equipped network through a first data set. The computing device may constitute a smartphone, a PDA, a laptop, etc.

Accordingly, at 202, the computing device is first activated and rendered into an operational state that allows the input and display of information. Thereafter, at 204, the user may be offered a prompt (or a plurality thereof) through the computing device display where a first data set may be presented in a plurality of fields such as, but not limited to, a name, an age, a platform, interests, and so on. Subsequently, at 206, the user may input the relevant information to the computing device through input means including, but not limited to, embedded keyboards, touch screens, voice input, etc. The first plurality of data may relate to the identity and information of the user to discretize holotag content captured by, manipulated, and saved by the user.

Then, at 208, the first data set is then uploaded to the local hardware of the computing device such as an onboard database or memory bank to officially register the user locally to the computing device. After uploading the first data set to the local hardware, the application may synchronize an extraneous display device, such as screen equipped glasses, to the computing device (at 210) simultaneously with optionally uploading the first data set to the cloud (at 212). Optionally, the first data set may be uploaded to the cloud if an internet connection is present and may occur simultaneously alongside the syncing of an extraneous display device when the computing device's wireless capabilities are engaged.

Accordingly, the method 200 may follow a linear registration algorithm to establish the user to the application on the computing device and proceeding to synchronize the extraneous display device to the computing device. Simultaneously, the user may opt to upload the first data set to a dedicated cloud network for financial transactions or social media participation.

FIG. 3 is a flowchart of a method 300 for initiating the operation phase for providing the interactive augmented reality experience in accordance with some embodiments. At 302, the method 300 may include initiating a prompt for operation mode to the display screen of the computing device. Further, at 304, the method 300 may include activating the extraneous display device. Whereupon the method 300 (or protocol) diverges into two separate but simultaneous processes of three steps each where the first path comprises in sequence: outputting a holotag display from the computing device at 306, displaying the holotag projection to the extraneous display device at 308, and altering the holotag projection based on orientation of the extraneous display device at 310. The second simultaneous path comprises in sequence: activating the computing device sensor at 312, observing gestures of the user in view of the computing device sensor at 314, and correlating the gesture of the user relative to the holotag projection at 316. The two paths may converge together again into a series of three steps in sequence: altering the holotag projection content with gesture feedback algorithm at 318, optionally capturing extraneous holotag content at 320, and storing captured extraneous holotag content to the local hardware at 322. Further, the operation may protocol between altering the holotag projection content with gesture feedback algorithm, to both outputting a holotag display from the computing device, and observing gestures of the user in view of the computing device sensor for the duration of the operation phase.

Following initiating the registration phase, the application may engage either an operation phase, or a shared operation phase. Preferably, the application may default to the operation phase concerning a protocol, wherein the user is a sole party to the application and broadcast of information to extraneous display devices.

Further, after the registration phase, the application may immediately initiate a prompt for operation mode to the display screen of the computing device. However, if the application is terminated and restarted, the application may preferably offer the operation phase as the preferred action of the onset of the program. The user may either manually engage their extraneous display device or the application may utilize the synchronization established during registration to override the manual activation of the extraneous display device. The extraneous display device may preferably be a pair of screen equipped glasses or a headset that possesses a proximity sensor attached arbitrarily but capable of quantifying the distance and orientation of the extraneous display device to the computing device and holotag projection content.

Upon activation of the extraneous display device and the initiation of the operation phase, the computing device may then output a holotag display from the computing device through the screen that may be readable to other computing devices and serve as an anchor for the holotag projection content. The holotag projection may then be displayed to the extraneous display device, wherein the device may produce an orientation, wherein the eyesight of the user is not obstructed relative to the holotag display. Through the proximity sensor located on the extraneous display device, the computing device may alter the holotag projection to reflect the orientation and proximity of the user's headset. This method may then repeat indefinitely for the length of the operation phase to permit a continuous interaction and engagement with the holotag projection content.

Further, simultaneously to the outputting of the holotag display from the computing device, the computing device sensor (or plurality thereof) may be activated. The compute device sensor may preferably utilize sensors including but not limited to visual sensors such as cameras, comprehensive light intensity sensors, sound-based sensors, and so on. The computing device sensor may be understood to be disparate of the dedicated sensor located on the computing device to detect and communicate with the proximity sensor located on the extraneous display device. The computing device sensor (or plurality thereof) may then observe the user's gestures in view of the computing device sensor that may coincide with the point in space that the holotag projection content is presently anchored and presented within. The computing device may utilize an algorithm that correlates the gesture of the user relative to the projected holotag and the content therein, such as if the user's finger visually is observed in the space over the computing device sensor and in proximity to the digitized holotag projection content, such as a ball.

Further, by tracking the location of the user's finger in space with respect to the holotag projection content, the algorithm may alter the holotag projection content through a gesture feedback algorithm, such as pushing or deforming the ball dependent on the computing capabilities of the computing device. This process may occur indefinitely and simultaneously alongside the streaming of information to the extraneous display device to present a continuous interaction experience wherein the user is engaged with the digital content. This method may be used for an operation as simple as playing with a ball, or engaging an optimized copy of the computing device that may be rescaled or manipulated, but still operate in the same manner as the computing device itself. This offers enhanced functionalities above the tangible computing device and also offers a privacy that only the user is party to. While in the operation mode and on the go, the user may optionally capture extraneous holotag content such as those embedded in stationary media, such as posters, or dynamic media, such as digitally streamed media or even other user's holotag displays given adequate permissions. Upon capturing this extraneous holotag content, the application may store the captured extraneous holotag content to the local hardware of the computing device for later review, programming, manipulation, or sharing.

Accordingly, the method 300 may proceed with the assumption the computing device is currently on, wherein a prompt may be engaged by the user, initiating the operation mode and with successful syncing, may activate the extraneous display device or establish a dedicated link to the computing device. Thereafter, the two simultaneous process flows may produce the gesture feedback algorithm that may continue throughout the operation phase, wherein the user may capture extraneous holotag content if the application is used in a public setting where a holotag is present.

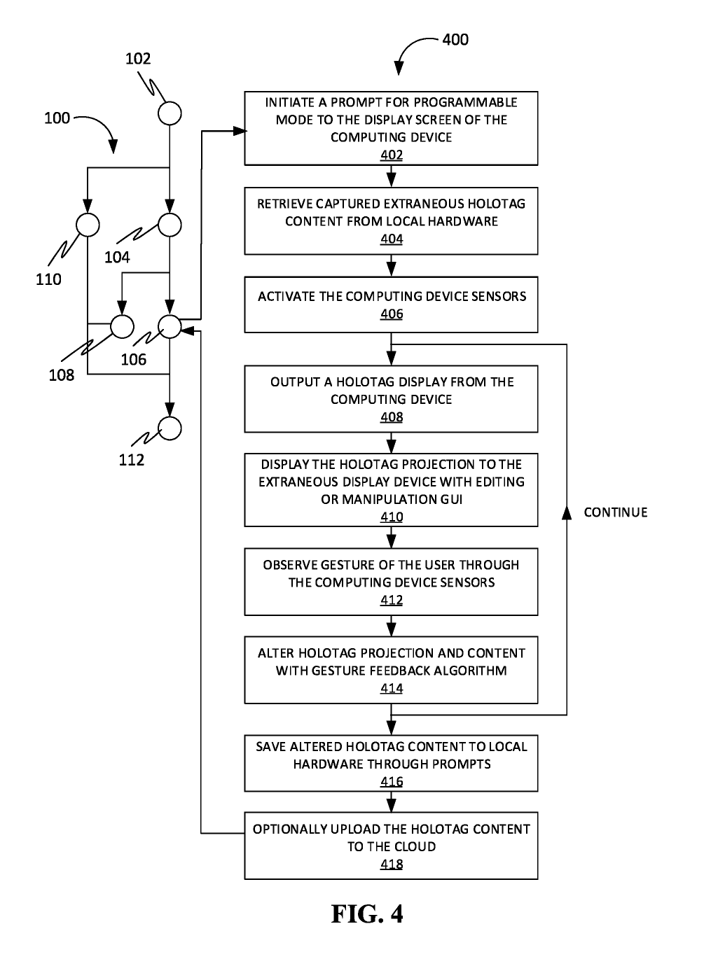

FIG. 4 is a flowchart of a method 400 for initiating the programmable phase for providing the interactive augmented reality experience in accordance with some embodiments. The method 400 may include initiating a prompt for the programmable mode to the display screen of the computing device at 402, retrieving captured extraneous holotag content from the local hardware at 404, activating the computing device sensors at 406, outputting a holotag display from the computing device at 408, displaying the holotag projection to the extraneous display device with an editing or manipulation graphical user interface (GUI) at 410, observing gestures of the user through the computing device sensors at 412, altering holotag projection and content with gesture feedback algorithm at 414, saving altered holotag content to local hardware through prompts at 406, and optionally uploading the holotag content to the cloud at 418. The programmable method may continuously loop between altering the holotag projection content with the gesture feedback algorithm (at 414) and output a holotag display from the computing device (at 408).

The initiation of the programmable phase may optimally proceed the operation phase once compatible holotag projection content has been captured or purchased through the market phase. The programmable phase may offer the user a means to customize or generate holotag projection content through a native editing or manipulation graphical user interface (GUI) that may be operated through the physical computing device's input means or optimally through the gestures of the user to test, craft, or alter the holotag projection content. After which, the user may upload the holotag projection content to the cloud, market, shared among friends, or anchored to an extraneous holotag for others to observe, manipulate, capture, or purchase.

Further, to initiate the programmable phase, a prompt may be initiated related to the programmable mode to the display screen of the computing device. Accordingly, the user may elect to accept or decline the programmable mode. Through either the computing device's native physical controls or preferably the gesture algorithm if following immediately after the operation mode, the user may retrieve a captured extraneous holotag content from the local hardware. Further, the user may additionally initiate a new holotag projection content from scratch with provided templates or programming foundations. The computing device's sensors may be then activated and may remain activated for the duration of the programmable phase if they were not already activated proceeding the operation phase.

Further, the holotag display may be then subsequently outputted from the computing device to permit either local users who are authorized to do so to observe the holotag projection content. The holotag projection may be then displayed to the extraneous display device with an editing or manipulation GUI that may permit the user to model, alter, and interact with the captured holotag projection content stored in the local hardware. Further, throughout the operation of the programmable phase, the gestures of the user may be observed through the computing device sensors in relation and proximity to the holotag projection content in the space above the computing device. The holotag projection content may be continually altered through the gesture feedback algorithm, wherein the extraneous display device is continually updated to reflect the interactions of the user.

Further, when deemed satisfactory to the user, the altered holotag content may then be saved to the local hardware of the computing device through a series of prompts that may include a plurality of fields concerning the name, designation, permissions, and so on. Optionally, upon saving the altered holotag content to the local hardware, the holotag content may be uploaded to the cloud to be shared with others, anchored to an extraneous holotag, or offered for purchase on the cloud market.

Accordingly, the method 400 may include the user bringing up captured extraneous holotag content stored in the local hardware and subsequently manipulated with in the editing or manipulation graphical user interface (GUI). During the course of editing and manipulation, the application may react to the user's gestures and actions and reflect such changes immediately to the extraneous display device. Further, the altered content may be saved to the local hardware of the computing device or shared with others either by implanting into the holotag or uploading to the cloud.

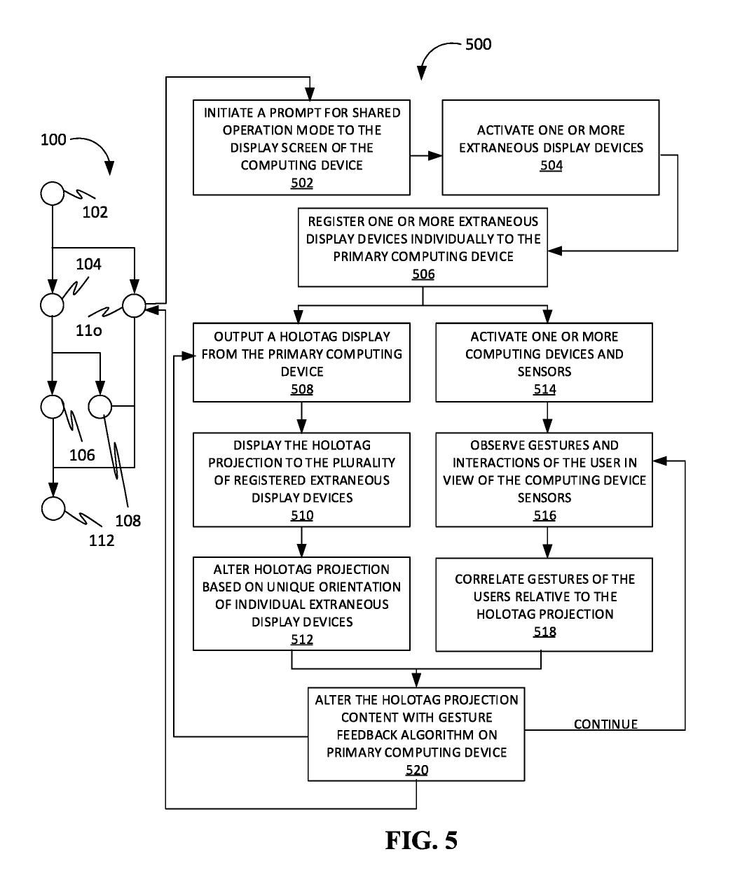

FIG. 5 is a flowchart of a method 500 for initiating the shared operation phase for providing the interactive augmented reality experience in accordance with some embodiments. The method 500 may include a series of three steps in sequence: initiating a prompt for shared operation mode to the display screen of the computing device at 502, activating one or more extraneous display devices at 504, and registering one or more extraneous display devices individually to the primary computing device at 506. The method 500 may diverge into two separate but simultaneous paths that comprise three steps each. The first path may include outputting a holotag display from the primary computing device at 508, displaying the holotag projection to the plurality of registered extraneous display devices at 510, and altering the holotag projection based on unique orientation of individual extraneous display devices at 512. The second path may include in sequence: activating one or more computing devices and sensors at 514, observing gestures and interactions of the user in view of the computing device sensors at 516, and correlating the gesture of the users relative to the holotag projection at 518. Thereafter the two paths may converge to a single step that comprises: altering the holotag projection content with gesture feedback algorithm on the primary computing device at 520. Further, the shared operation mode may loop continuously therefrom to both outputting a holotag display from the primary computing device (at 508), and observing gestures and interactions of the users in view of the computing device sensors (at 514).

Further, if the user at the conclusion of the registration phase chooses to allow multiple users to engage with the holotag projection content or view, a shared operation phase may be initiated that may allow multiple registered users to be party to the standard operation phase of application, or offer enhanced sensor capability by utilizing a larger plurality of sensors than a standalone computing device may offer.

Further, to initiate the shared operation phase, a prompt for shared operation mode may be forwarded to the display screen of the computing device on demand, where the user may authorize or deny the shared operation mode. Upon recognition and initiating the shared operation mode, one or more extraneous display devices may be activated. These alternative extraneous display devices may alter from the user's extraneous display device but may require a compatible proximity sensor that can engage with the user's computing device as the primary computing device. The one or more extraneous display devices may be then registered individually to the primary computing device either through a shared application registration and authorization granted between the other user's computing devices. Alternatively, the authorization of viewing may be granted through the primary computing device of the initial user that initiated the shared operation mode and subsequently synchronize the one or more extraneous display devices similar to the registration phase. Additionally, one or more computing devices may be registered at this stage either through a shared authorization acknowledgement or pre-registered relationships that may expand the number of sensors that the application can make use of in the local area. Such a method may effectively line a room in sensors or solely utilize the primary computing device's sensors to offer a wide range of sensory and potentially processing power that can be spread out across the computing device network.

Subsequently, the application may follow a method similar to the operation phase, wherein the holotag display may be outputted from the primary computing device's display screen. Thereafter the holotag projection content may be displayed to the plurality of registered extraneous display devices similarly to the user's own extraneous display device. In altering the holotag projection based on the unique orientation of the individual extraneous display devices, the computing device may communicate with the proximity sensors of the one or more extraneous display devices through a discretizing algorithm that may separately handle each extraneous display device relative to the unique orientation and proximity relative to the primary computing device. The alteration may immediately impact the angle of view, the magnification in proximity to the holotag projection content, and any engagements made by the user through gestures produced over the computing device sensors or the plurality thereof.

Simultaneously with the output of the holotag display from the primary computing device, the activation of one or more computing devices and sensors occurs that may solely involve the user's primary computing device, or engage one or more computing devices that may expand the field of sensors available to the primary computing device. Thereafter, gestures and interactions of the user (or the plurality thereof) in view of the computing device sensors may be observed. Primarily, the primary computing device may serve as the basic collection of sensors but may, in the shared operation mode, permit a plurality of one or more computing devices to be registered and linked to the primary computing device and subsequently an equal or greater plurality of sensors. Therefore, the level of engagement the primary computing device and the holotag projection content may be as simple as a single manipulatable object, or as comprehensive as a room lined sensor field that can handle multiple manipulatable objects in a single instance. Similar to the operation phase, the application phase may utilize an algorithm that correlates the gestures of the users relative to the holotag projection by taking in information from the primary computing device's sensors and one or more computing device sensors that may expand the field of view and depth available to the application.

Further, the holotag projection content may be altered continuously with the gesture feedback algorithm preferably located on the primary computing device, although theoretically the computing demand may be shared among the computing devices to handle more intensive interactive objects.

Accordingly, the method 500 may include the user operating their computing device as the primary computing device and share the holotag projection content shown and interacted with to one or more extraneous display devices and subsequently one or more other users. The method 500 then further allow the operation and use of one or more computing devices and subsequently sensors to provide a more comprehensive sensor array that can augment an entire room. The method 500 may permit the immediate response to gestures and correlations thereof to the holotag projection content and extraneous display devices to allow multi-user interactions channeled through the primary computing device.

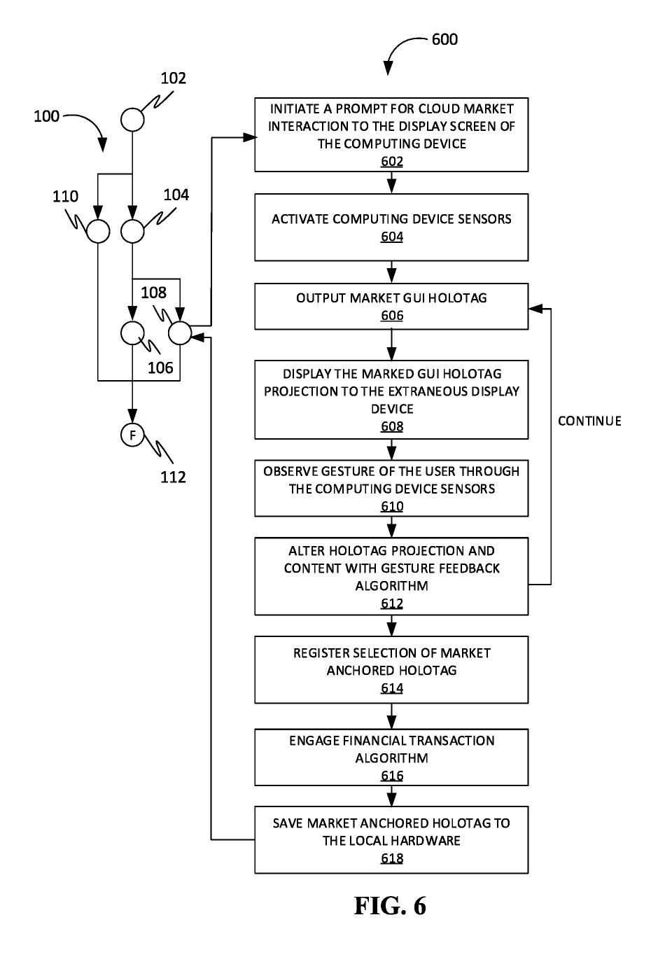

FIG. 6 is a flowchart of a method 600 for initiating the market phase for providing the interactive augmented reality experience in accordance with some embodiments. The method 600 may include a sequence of nine steps in sequence: initiating a prompt for cloud market interaction to the display screen of the computing device at 602, activating computing device sensors at 604, outputting a market GUI holotag at 606, displaying the market GUI holotag projection to the extraneous display device at 608, observing gestures of the user through the computing device sensors at 610, altering holotag projection and content with gesture feedback algorithm at 612, registering selection of market anchored holotag at 614, engaging a financial transaction algorithm at 616, and saving market anchored holotag to the local hardware at 618. Further, the market phase method 600 may loop continuously from altering the holotag projection (at 612) and content with the gesture feedback algorithm to outputting the market GUI holotag (at 606).

The initiation of the market phase may preferably proceed the operation phase. The operation mode's protocol may enable viewing the market available content in holotag projection form, but may alternatively initiate the holotag projection and gesture feedback algorithm at the onset of the market phase. The market phase may connect to the cloud and market network wherein vendor or extraneous user supplied holotags may be exchanged with a financial transaction algorithm that draws on the information provided in the registration phase.

Further, a prompt for cloud market interaction may be initiated and forwarded to the display screen of the computing device, wherein the user may confirm or deny the activation of the cloud market interaction mode through physical inputs on the computing device or through gestures within the operation mode gesture feedback algorithm. If the computing device sensors are not already activated, the application may engage and activate the computing device sensors to allow a preferable gesture driven cloud market interaction.

Further, the market GUI holotag may be subsequently outputted to the computing device display screen. Further, an extraneous registered user may be allowed to peruse the cloud market in tandem with the initial user such as couples or the like when authorized on the computing device. The market GUI holotag projection may be then displayed on the extraneous display devices constituted of a virtualized, digitized market interface that the user may scroll through and select with appropriate gestures. The computing device may then proceed to observe the gestures of the user through the computing device sensors in relation and proximity to the digitized market GUI projection. The computing device may then alter the holotag projection and content of the market GUI holotag with the gesture feedback algorithm by altering the selection, angle of view, or any manipulatable elements and reflecting such changes to the extraneous display device.

Moreover, upon reaching a desired option within the market GUI holotag projection, the computing device may register the selection of a market anchored holotag that may optionally provide immediate interaction or otherwise demonstration authorized content. Further, the computing device may engage a financial transaction algorithm that makes use of the first data set and information therein concerning the user, potentially age, financial institution or payment information, to authorize and transfer the market anchored holotag from the market place to the user and the exchange of payment from the user to the market place and subsequently the vendor's financial institution. The computing device may then save the market anchored holotag to the local hardware and preferably lifts most if not all restrictions on the market anchored holotag to enable to user to freely interact and reasonably manipulate within the programmable phase of the application.

Accordingly, the method 600 may allow the user to engage in a cloud network based plurality of users and vendors to purchase and offer holotag content to their computing device wherein they may view the holotag content to some capacity as though bought.

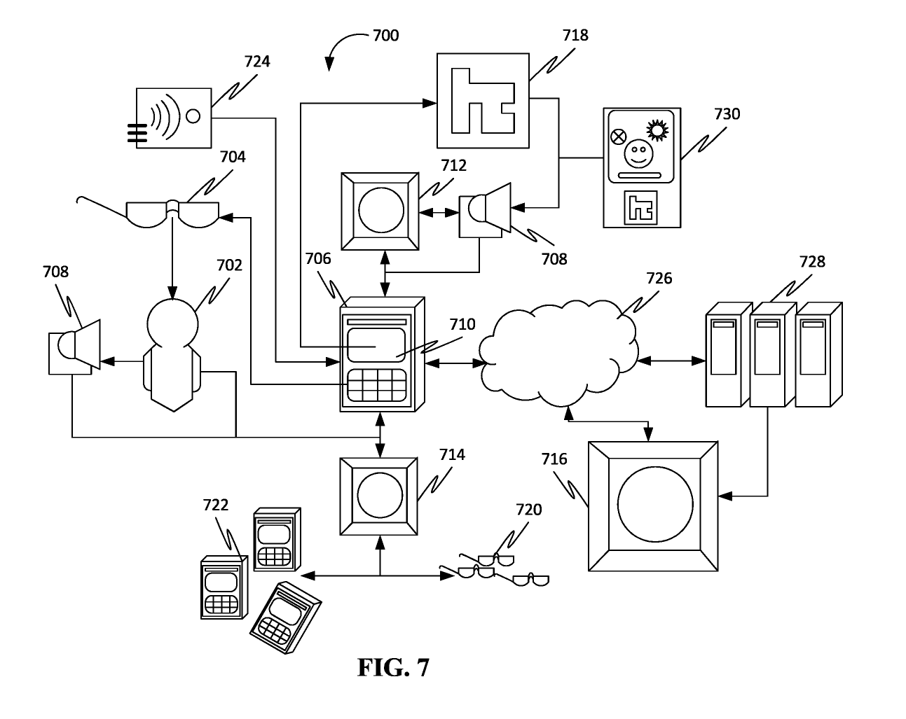

FIG. 7 illustrates a system 700 for providing the interactive augmented reality experience in accordance with some embodiments. A user 702 may wear an extraneous display device 704, interact with a computing device 706, and may engage a sensor 708 through gestures in view of the sensor 708. The computing device 706 may engage the operation, shared operation, and a cloud network 726 while being acted upon by the user 702 and sensors 708, 722. The computing device 706 may further include a computing device display screen 710 that outputs the holotag display. The computing device display screen 710 may be comprised within the computing device 706 and outputs the holotag display. An operation phase program 712 may communicate between the computing device 706 and the sensor 708 while supplying the holotag projection content to the extraneous display device 704.

Further, a shared operation mode program 714 may allow communication between the computing device 706 as the primary computing device, one or more other computing devices, and one or more extraneous display devices to share the output of the primary computing device to all registered extraneous display devices.

Further, a market mode program 716 may communicate between the cloud network 726 and a remote database 728 of information supplied by both communicating devices and vendors. Further, the user may opt into a market mode and conduct business or patronage.

A holotag 718 may be outputted from the computing device display 710 in the local instance. The sensor 708 may detect local holotags located on the computing device 706, extraneous holotags 730 located on other computing devices or extraneous media such as posters, and additionally receives input from the user through gestures made in proximity to the holotag projection.

The extraneous display device 704 may be a pair of screen equipped glasses or other headgear and is worn by the user. The headgear may be connected to a proximity sensor for orientation to the computing device and holotag projection content. The extraneous display device 704 may further supply a stream of images and data from the computing device 706.

Further, an instance of one or more extraneous display devices 720 may share holotag projection content with the primary computing device 706 during a shared operation mode.

Further, an instance of one or more computing devices 722 that may be utilized to modularly expand the sensor capacity and enable a larger environment to utilize gestures during the shared operation mode.

Further, a proximity sensor 722 may be equipped to the extraneous display device 704 and may define the location and orientation of the extraneous display device 704 in relation to the computing device 706 and holotag projection content.

Further, the cloud network 724 may be augmented by the application wherein the market mode may engage, utilize and additionally communicate with the remote database 728.

Further, the remote database 728 may store the information of the computing device's user and registration information, as well as offering augmented conventional services that are optimized for the application to use such as email, chat, videos, and so on.

Further, the extraneous holotag 730 may be embedded onto external media, structures, or running entertainment wherein the sensor of the computing device 706 may observe, interact, and even capture to store into the local hardware of the computing device 706.

According to embodiments, the present disclosure provides augmented reality experience through a registration, operation, programmable, shared operation, and market phase protocol that enables the user to additionally synchronize one or more extraneous computing devices and one or more extraneous display devices. Further, the user may be able to turn on the computing device, put on their extraneous display device such as a screen equipped pair of glasses and synchronize to the computing device. Thereafter, the user may observe a startup hologram or holotag projection content, and the user may operate a digitized and virtual computing device. Thereafter, the user may go through messages, engage a virtual keyboard to produce an email, or even open up a video streaming service to watch the video content on the virtual computing device. Further, the disclosure relates to devices that also produce interactive objects from external producers or produced natively in the programmable mode wherein content may be captured in the operation or market phase of the protocol. By engaging in the shared operation mode, multiple extraneous computing devices may interact with the primary computing device that expands the view and field of the sensors through a handshaking protocol that syncs the extraneous computing devices. The same protocol may additionally broadcast multiple discretized streams of information to an equal count of extraneous display devices that uniquely reflect orientation and proximity to the holotag projection content. Thus, the present disclosure may offer a universalized augmented reality experience that may agilely engage multiple computing devices and sensors, multiple extraneous display devices, and offer a highly mutable platform to engage a multitude of augmented reality and holotag projection content.

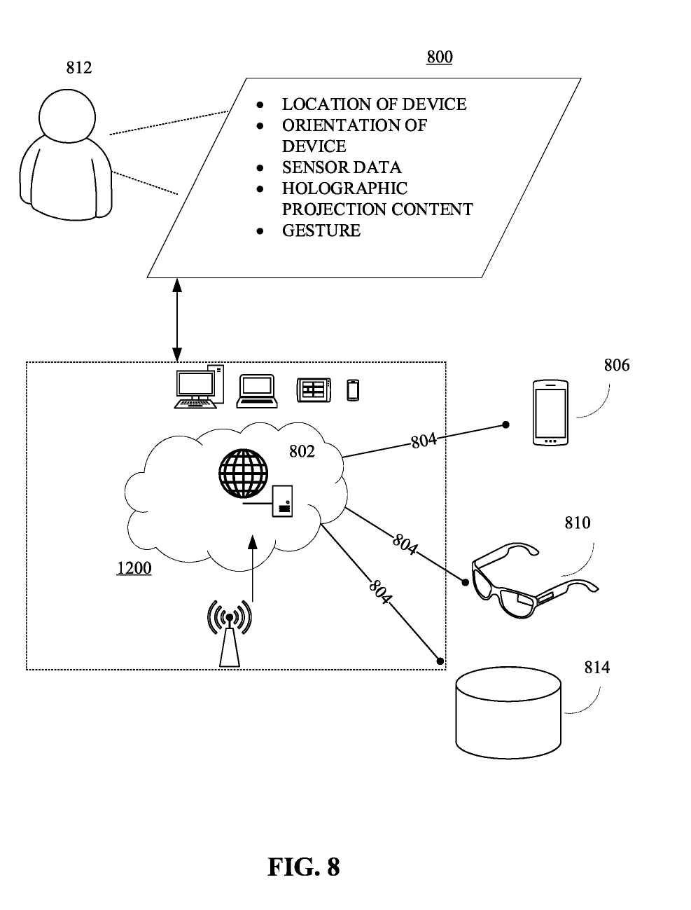

FIG. 8 is an illustration of a platform 800 consistent with various embodiments of the present disclosure. By way of non-limiting example, the online platform 800 for facilitating provisioning of holographic content may be hosted on a centralized server 802, such as, for example, a cloud computing service. The centralized server 802 may communicate with other network entities, such as, for example mobile devices 806 (such as a smartphone, a laptop, a tablet computer etc.), wearable devices 810 (such as smart glasses, etc.), databases 814 (such as holographic content databases), via a communication network 804 such as, but not limited to, the Internet. Further, users of the platform may include one or more relevant parties such as users, content providers, companies and system administrators. Accordingly, electronic devices operated by the one or more relevant parties may be in communication with the platform 800.

A user 812, such as the one or more relevant parties, may access the platform 800 through a software application. The software application may be embodied as, for example, but not be limited to, a website, a web application, a desktop application, and a mobile application compatible with a computing device 2000.

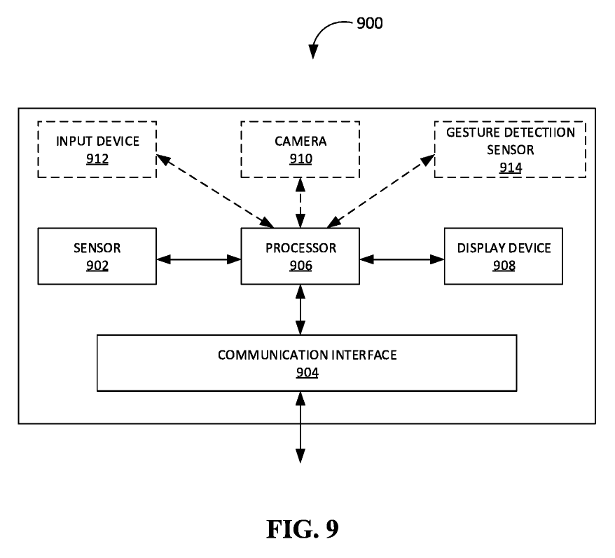

FIG. 9 is a block diagram of a wearable display device 900 configured to facilitate provisioning of holographic content in cooperation with one or more computing devices in accordance with some embodiments. The holographic content may include a virtual three-dimensional image of an object. Further, the wearable display device 900 may be smart glasses, such as Microsoft HoloLens™ and Google Glass™, The wearable display device 900 may include one or more sensors 902 configured to detect sensor data corresponding to one or more of a location and an orientation of the wearable display device 900.

Further, the wearable display device 900 may include a communication interface 904 configured to transmit the sensor data to the one or more computing devices. The communication interface 904 may be configured to receive holographic projection content from the one or more computing devices. The communication interface may include one or more of a wired communication interface and a wireless communication interface. For example, the communication interface may be based on a near-field communication protocol such as, but not limited to, Bluetooth, ZigBee, Infrared (IR) communication, RFID and so on. Alternatively, and/or additionally, the wireless communication interface may be based on a wireless network such as, but not limited to, WiFi, WiMax, Wibro, WiGig, WLAN etc. Further, the holographic projection content may be generated by the one or more computing devices based on the sensor data.

Further, the wearable display device 900 may include a processor 906 communicatively coupled to the communication interface 904. Further, the processor 906 may be configured to process the holographic projection content.

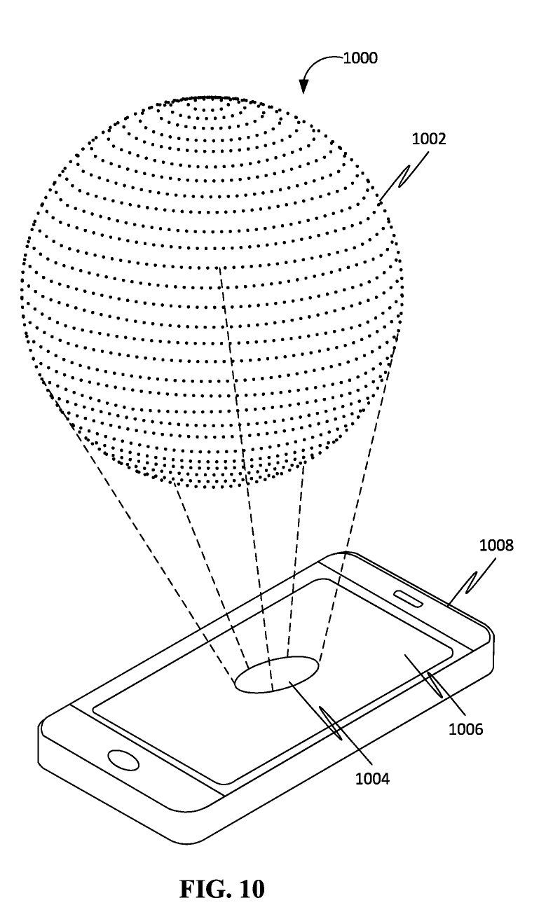

Further, the wearable display device 900 may include a display device 908 communicatively coupled to the processor 906. Further, the display device 908 may be configured to generate a visual display of the holographic projection content. As shown in FIG. 10, the display device 908 may generate a visual display of the holographic projection content comprising a virtual ball 1002.

In some embodiments, the wearable display device 900 may further include one or more optical markers configured to facilitate determination of one or more of the location and the orientation. For example, the optical marker may be one of a linear barcode and a matrix (2D) barcode (such as a QR code). Further, the one or more computing devices may be configured to perform the determination based on at least one image of the one or more optical markers.

In some embodiments, the wearable display device 900 may further include a camera 910 communicatively coupled to the processor 906. For example, the camera 910 may include an electronic image sensor, such as a charge-coupled device (CCD) or a CMOS sensor to capture images. Further, the camera 910 may be configured to capture one or more holotags. Accordingly, the one or more holotags may include optically encoded information. For example, the one or more holotags may include a barcode, a QR code and so on. Further, the processor 906 may be configured to analyze the one or more holotags. Further, the communication interface 904 may be configured to establish a communication session with the one or more computing devices based on the analysis of the one or more holotags. Further, the communication session may include one or more of transmission of the sensor data and reception of the holographic projection content.

In some embodiments, the one or more holotags may be rendered on one or more displays of the one or more computing devices. For example, as shown in FIG. 10, a holotag 1004 may be rendered on a display 1006 of a mobile device 1008. Further, the holographic projection content may be anchored to the one or more holotags. As shown in FIG. 10, the ball-shaped holographic projection content 1002 may be anchored to the holotag 1004.

In some embodiments, the one or more holotags may be imprinted on a physical object. For example, the physical object may be an artifact in a museum. Accordingly, the communication interface 904 may be further configured to transmit the one or more holotags to the one or more computing devices.

In some embodiments, the wearable display device 900 may further include an input device 912 configured to receive authentication data. For example, the input device 912 may include at least one biometric sensor configured to detect a biometric variable associated with one or more users. For example, the at least one biometric sensor may be related to one or more of fingerprint recognition, face recognition, iris recognition, voice recognition. Accordingly, the authentication data may also include the biometric variable. Further, the communication interface 904 may be configured to transmit the authentication data to the one or more computing devices. Further, the one or more computing devices may be configured to authenticate the wearable display device 900 based on the authentication data. Further, reception of the holographic projection content may be based on authentication of the wearable display device 900.

In some embodiments, the wearable display device 900 may further include one or more gesture detection sensors 914 communicatively coupled to the processor 906. For example, the one or more gesture detection sensors 914 may include a hand gesture recognition sensor that utilizes ultra-wideband impulse signals, which are reflected from a hand of a user. Further, the one or more gesture detection sensor 914 may be configured to detect gesture sensor data. Further, the processor 906 may be configured to detect one or more gestures performed by one or more users based on the gesture sensor data. Further, the communication interface 904 may be configured to transmit indication of the one or more gestures to the one or more computing devices. Yet further, the communication interface 904 may be configured to receive an updated holographic projection content from the one or more computing devices. The updated holographic projection content may be generated by the one or more computing devices based on the indication of the one or more gestures.

For example, the one or more gestures may include a user using his hand to flick the ball-shaped holographic projection content 1002. Accordingly, the updated holographic projection content received from the one or more computing devices may include the ball-shaped holographic projection content 1002 rotated by a certain degree in the direction of the flick gesture.

In further embodiments, the processor 906 may be configured to determine a spatial correlation between the one or more gestures and the holographic projection content. The processor 906 may be further configured to detect the one or more gestures further based on the spatial correlation.

In some embodiments, the communication interface 904 may be further configured to receive an updated holographic projection content from the one or more computing devices. Further, the updated holographic projection content may be generated by the one or more computing devices based on one or more gestures performed by one or more users. Further, the one or more computing devices may include one or more gesture detection sensors configured to detect the one or more gestures. Further, the one or more computing devices may be further configured to generate the updated holographic projection content based on the one or more gestures.

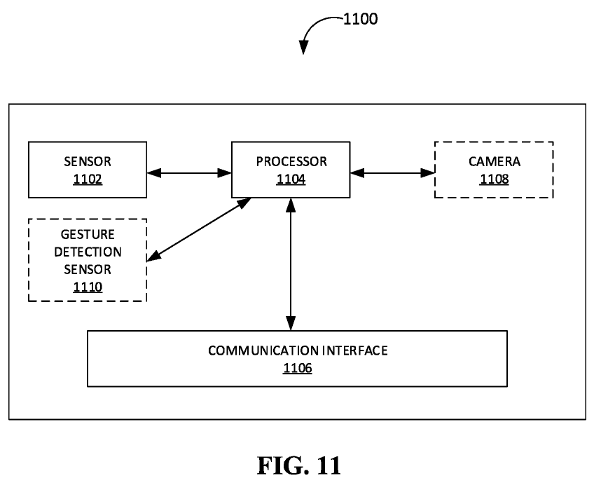

FIG. 11 is a block diagram of a computing device 1100 configured to facilitate provisioning of holographic content in cooperation with one or more wearable display devices (such as wearable devices 810) in accordance with some embodiments. The computing device 1100 may include one or more sensors 1102 configured to detect sensor data corresponding to one or more of a location and an orientation of the one or more wearable display devices.

Further, the computing device 1100 may include a processor 1104 communicatively coupled to the one or more sensors 1102. Further, the processor 1104 may be configured to generate at least one holographic projection content based on the sensor data.

Further, the computing device 1100 may include a communication interface 1106 configured to transmit the at least one holographic projection content to the one or more wearable display devices. Further, the one or more wearable display devices may be configured to generate at least one visual display of the holographic projection content.

In some embodiments, the one or more wearable display devices may include a plurality of wearable display devices. Further, the sensor data may include one or more of a plurality of locations and a plurality of orientations corresponding to the plurality of wearable display devices. Further, the at least one holographic projection content may include a plurality of holographic projection content corresponding to one or more of the plurality of locations and a plurality of orientations.

In some embodiments, the one or more sensors 1102 may include a camera 1108 configured to capture at least one image of at least one optical marker disposed on the one or more wearable display devices. Further, the processor 1104 may be configured to analyze the at least one image. Yet further, the processor 1104 may be configured to determine one or more of the location and the orientation of the one or more wearable devices based on analysis of the at least one image.

In some embodiments, the camera 1108 may be configured to capture one or more holotags. Further, the processor 1104 may be configured to analyze the one or more holotags. Further, the communication interface 1106 may be configured to establish a communication session with the one or more wearable display devices based on the analysis of the one or more holotags. Further, the communication session may include transmission of the at least one holographic projection content to the one or more wearable display devices.

In some embodiments, the computing device 1100 may further include at least one gesture detection sensor 1110 communicatively coupled to the processor 1104. Further, the at least one gesture detection sensor 1110 may be configured to detect gesture sensor data. Further, the processor 1104 may be configured to detect one or more gestures performed by one or more users associated with the one or more wearable display devices based on the gesture sensor data. Further, the processor 1104 may be further configured to generate an updated holographic projection content based on the gesture sensor data. Further, the communication interface 1106 may be further configured to transmit the updated holographic projection content to the one or more wearable display devices.

In some embodiments, the processor 1104 may be further configured to determine at least one spatial correlation between the at least one gesture and the at least one holographic projection content. Further, the processor 1104 may be configured to detect the at least one gesture further based on the at least one spatial correlation.

According to some embodiments, a method for providing holographic content based on the cooperation of at least one computing device and at least one extraneous display device is disclosed. The at least one extraneous display device may include a screen equipped pair of glasses. Further, the at least one computing device may include at least one of a laptop computer, a smartphone, a desktop computer and a wearable computer.

Further, the at least one computing device may be configured to receive identifying information associated with at least one user. Yet further the at least one computing device is further configured for uploading the identifying information to a cloud storage.

Further, the method may include establishing, using a communication interface, a communication session between the at least one computing device and the at least one extraneous display device. In some embodiments, the at least one computing device may be configured to synchronize with the at least one extraneous display device. Further, in some embodiments, the at least one computing device is configured to synchronize with a plurality of extraneous display devices. The method may further include registering each of the plurality of extraneous display devices with the at least one computing device.

Further, the method may include determining, using at least one sensor, sensor data corresponding to one or more of a location and an orientation associated with the at least one extraneous display device.

Further, the method may include generating, using a processor, holographic projection content based on the sensor data. Further, the method may include transmitting, using the communication interface, the holographic projection content from the at least one computing device to the at least one extraneous display device. Further, the at least one extraneous display device may be configured for displaying the holographic projection content.

In some embodiments, the at least one extraneous display device may include a proximity sensor and an orientation sensor, wherein the proximity sensor is configured to determine a distance of the at least one extraneous display device to the computing device, wherein the orientation sensor is configured to determine an orientation of the at least one extraneous display device in relation to the computing device.

In some embodiments, the method may further include receiving at least one registration data associated with at least one extraneous display device. Further, the establishing of the communication session may be based on the at least one registration data.

In some embodiments, the method may further include determining, using a gesture detection sensor, at least one gesture associated with the at least one user; generating, using the processor, an updated holographic projection content; transmitting, using the communication interface, the updated holographic projection content from the at least one computing device to the at least one extraneous display device.

In some embodiments, the method may further include determining, using the processor, at least one correlation between the at least one gesture and the holographic projection content. Further, the generating of the updated holographic projection content may be based on the at least one correlation.

In some embodiments, the at least one computing device comprises a display screen configured to generate a holographic projection. Further, the at least one computing device may be configured to generate the holographic projection, wherein the at least one computing device may be further configured to transmit the holographic projection content to the at least one extraneous display device.

In further embodiments, the at least one computing device may include a gesture detection device configured to detect a gesture performed by at least one user. Further, the at least one computing device is configured to determine a correlation between the gesture and the holographic projection content generated by the at least one computing device, wherein the at least one computing device is further configured to generate an updated holographic projection content based on a holographic projection content and the gesture. Moreover, the method may include storing, using a storage device, the updated holographic projection content.

Further, the holographic projection may include a projection of a virtual representation of the at least one computing device, wherein the virtual representation is configured to provide optimum user interaction.

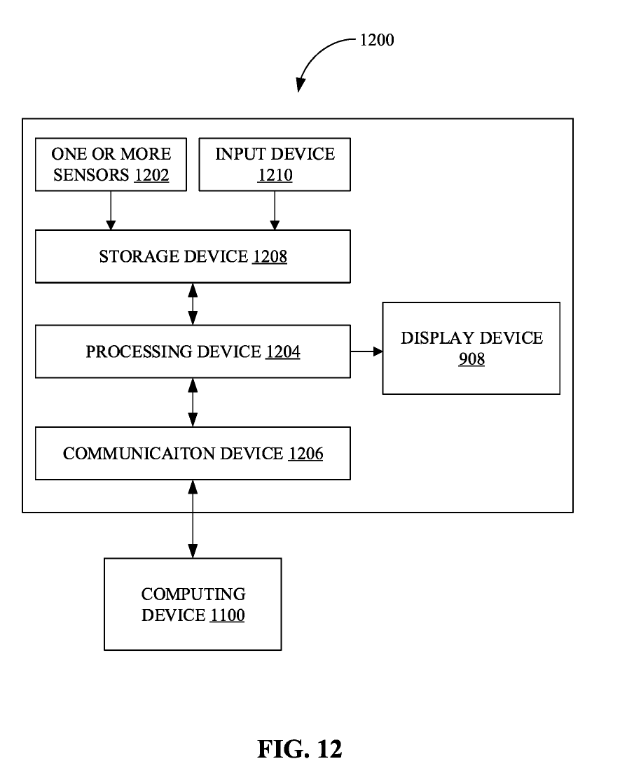

FIG. 12 illustrates a block diagram representation of a wearable display device 1200 that may be configured to project and/or customize a holographic projection content based on one or more characteristics of a user, in accordance with some embodiments. The one or more characteristics of the user, in an instance, may be features that may reveal something of interest about the user with regard to a generation of the holographic projection content. The one or more characteristics of the user, in an instance, may include physical features associated with the user such as height, weight, dimensions of hands and/or fingers, skin tone etc. Further, the one or more characteristics of the user, in an instance, may include, but not limited to, personal preferences of the user with regard to the holographic projection content that may be displayed by the wearable display device 1200 (such as the personal preference of the user with regard to a size and/or a color of any holographic projection content that may be displayed by the wearable display device 1200). Further, the wearable display device 1200, in an instance, may include, but not limited to, a one or more of sensors, a processing device 1204, a communication device 1206, the display device 908 etc. Further, the wearable display device 1200, in an instance, may be configured to sense a sensory data from the one or more sensors 1202. The sensory data, in an instance, may be any data that may be sensed by the one or more sensors 1202 and/or may reflect the one or more characteristics of the user when processed by the processing device 1204. Further, the one or more sensors 1202, in an instance, may include, but not limited to, camera sensors, positions sensors, orientation sensors, ultrasonic sensors, gyro sensors, IR sensors, microphone etc. Further, the processing device 1204, in an instance, may be configured to analyze the sensory data in order to determine the one or more characteristics of the user. Further, the processing device 1204, in an instance, may carry out a computer program by performing arithmetic, logical, and/or control operations for determining the one or more characteristics of the user. For instance, the physical features (such as the size of hands) of the user may be determined by analyzing, using the processing device 1204, the sensory data from the one or more sensors 1202 (such as the camera sensor, ultrasonic sensors, and/or the IR sensors). Further, the one or more characteristics of the user analyzed by the processing device 1204, in an instance, may be transmitted to the computing device 1100 through the communication device 1206. Further, the computing device 1100, in an instance, may customize and/or alter the holographic projection content in a way such that the holographic projection content generated by the computing device 1100 may be based on the one or more characteristics of the user. Further, the holographic projection content, in an instance, may be transmitted to the display device 908 that may be a visual display configured to project the holographic projection content to the user. For instance, the holographic projection content (such as a ball) may be altered (by changing the diameter of the ball) by the computing device 1100 based on the characteristics of the user (such as the size of the hands of the user) in a way such that the ball (holographic projection content) may fit perfectly on the hands of the user.

In an exemplary embodiment, the wearable display device 1200 configured to facilitate provisioning of holographic content in cooperation with at least one computing device (such as the computing device 1100). Further, the wearable display device 1200 may include at least one sensor (such as the one or more sensors 1202) configured to detect sensor data corresponding to one or more of a location and an orientation of the wearable display device 1200. Further, in some embodiments, the at least one sensor may be configured to detect at least one contextual value of at least one contextual parameter. In some embodiments, the at least one contextual parameter may include at least one environmental characteristic and at least one user characteristic (and/or the one or more characteristics of the user). Further, the at least one environmental characteristic, in an instance, may include any feature that may be associated with a surrounding environment of the wearable display device 1200. For instance, the at least one environmental characteristic may include feature such as luminosity level, temperature, humidity level etc. associated with the surrounding environment of the wearable display device 1200. Further, the location may include a geo-spatial location. Further, the geo-spatial location, in an instance, may be a real-world geographical location of any object. Further, the at least one sensor, in an instance, may include (but not limited to) a camera that may be configured to read the geo-spatial location from a visual marker (such as barcode, location name, location coordinates etc.). Further, the at least one sensor, in an instance, may include, but not limited to, a GPS sensor for generating the geo-spatial location. Further, the holographic projection content, in an instance, may be based on the geo-spatial location associated with (but not limited to) the user, the wearable display device 1200, and/or the computing device etc. Further, the wearable display device 1200 may include a communication interface (such as the communication device 1206) configured to transmit the sensor data to the at least one computing device. Further, the communication interface may be configured to receive the holographic projection content from the at least one computing device. Further, in some embodiments, the communication interface may be configured to transmit the at least one contextual value. Further, the holographic projection content may be generated by the at least one computing device based on the sensor data. Further, in some embodiments, the holographic projection content generated by the at least one computing device may be based on the at least one contextual value. Further, the wearable display device 1200 may include a processor (such as the processing device 1204) communicatively coupled to the communication interface. Further, the processor may be configured to process the holographic projection content. Further, the wearable display device 1200 may include the display device 908 communicatively coupled to the processor. Further, the display device 908 may be configured to generate the visual display of the holographic projection content.

Further, in some embodiments, the at least one sensor may include a geo-location sensor. Further, the geo-location sensor, in an instance, may be configured for detecting the geo-spatial location.

In some embodiments, the wearable display device 1200 may further include at least one optical marker configured to facilitate determination of one or more of the location and the orientation. For example, the optical marker may be one of a linear barcode and a matrix (2D) barcode (such as a QR code). Further, the location may include at least one relative location of the wearable display device 1200 with respect to the at least one computing device. Further, the at least one computing device may be configured to perform the determination based on at least one image of the at least one optical marker.

In some embodiments, the wearable display device 1200 may include a camera (not shown in FIG. 12) communicatively coupled to the processor. For example, the camera may include an electronic image sensor, such as a charge-coupled device (CCD) or a CMOS sensor to capture images. Further, the camera may be configured to capture at least one holotag. Accordingly, the at least one holotag may include optically encoded information. For example, the at least one holotag may include a barcode, a QR code and so on. Further, in some embodiments, the at least one holotag may be rendered on at least one display (such as the display device 908) of the at least one computing device. Further, the holographic projection content may be anchored to the at least one holotag. Further, in some embodiments, the at least one holotag may be imprinted on a physical object. Further, the communication interface may be further configured to transmit the at least one holotag to the at least one computing device. Further, the processor may be configured to analyze the at least one holotag. Further, the communication interface may be configured to establish a communication session with the at least one computing device based on the analysis of the at least one holotag. Further, the communication session may include one or more of transmission of the sensor data and reception of the holographic projection content.

Further, in some embodiments, the wearable display device 1200 may further include at least one sound producing device configured for generating sound based on audio content associated with the holographic projection content. Further, the at least one sound producing device, in an instance, may include device such as (but not limited to) a speaker. Further, the audio content, in an instance, may be any audible content associated with the holographic projection content. For instance, the audio content may include (but not limited to) audible phrases in a certain language (such as English) that may allow the user to verbally interact with the holographic projection content. Further, in another instance, the audio content may include (but not limited to) chime sound and/or an alert sound that may be used by the wearable display device 1200 to notify and/or alert the user. Further, in some embodiments, the audio content may be generated by the at least one computing device based on the sensor data. In some embodiments, the audio content may be generated by the at least one computing device based on the geo-spatial location. Further, the at least one sound producing device may be communicatively coupled to the processor. Further, the communication interface may be further configured to receive the audio content from the at least one computing device (such as the computing device 1100).

Further, in some embodiments, the wearable display device 1200 may include an input device 1210 configured to receive at least one user input. Further, the at least one user input, in an instance, may include (nut not limited to) selecting the holographic projection content, creating the holographic projection content, modifying the holographic projection content etc. Further, the input device 1210, in an instance, may be any device that may allow the user to provide the at least one user input. Further, the input device 1210, in an instance may include (but not limited to) a touchscreen panel, a keyboard, a mouse etc. Further, the input device 1210 may be communicatively coupled to one or more of the processor (such as the processing device 1204) and/or the at least one computing device (such as the computing device 1100). Further, the at least one computing device may be configured to generate the holographic projection content based on a first user input. Further, the first user input, in an instance, may be any input from a first user through the input device 1210. For instance, the first user input may include a creation of the holographic projection content by the first user through the input device 1210. Further, the at least one computing device may be configured to generate an association between the holographic projection content and the sensor data based on a second user input. Further, the second user input, in an instance, maybe any input from a second user through the input device 1210. For instance, the second user input may include dropping and/or pinning the holographic projection content at the geo-spatial location by the second user through the input device 1210. Further, the at least one computing device may include a storage device 1208 configured for storing the sensor data in association with the holographic projection content.

In some embodiments, the input device 1210 may include at least one gesture detection sensor communicatively coupled to the processor. Further, the at least one gesture detection sensor, in an instance, may include (but not limited to) a hand gesture recognition sensor that may utilize ultra-wideband impulse signals, which may be reflected from a hand of a user. Further, the at least one gesture detection sensor may be configured to detect gesture sensor data. Further, the processor may be configured to detect at least one gesture performed by at least one user (such as a gesture from the hand of the user) based on the gesture sensor data. Further, the communication interface may be configured to transmit indication of the at least one gesture to the at least one computing device. In some embodiments, the at least one gesture may include a first gesture corresponding to the first user input and a second gesture corresponding to the second user input. For instance, the first gesture corresponding to the first user input may include a movement of a hand of the first user (such as in a circular motion) in order to modify the holographic projection content. Further, in another instance, the second gesture corresponding to the second user input may include a movement of a hand of the second user (such as in a vertical motion) in order to pin and/or drop the holographic projection content at the geo-spatial location. Further, in some embodiments, the at least one gesture may include a third gesture configured to function as a trigger. Further, the storage device 1208 may be configured for storing indication of the third gesture in association with the holographic projection content and the sensor data. Further, the communication interface may be configured to receive an updated holographic projection content from the at least one computing device. Further, the updated holographic projection content, in an instance, may be the holographic projection content that may be altered and/or modified based on the gesture data that may be analyzed by the at least one processor and/or the at least one computing device. Further, the updated holographic projection content may be generated by the at least one computing device based on the indication of the at least one gesture. Further, in some embodiments, the generation of the holographic projection content may include modification of the holographic projection content based on the first gesture. In some embodiments, the processor may be configured to determine a spatial correlation between the at least one gesture and the holographic projection content. Further, the processor may be configured to detect the at least one gesture based on the spatial correlation.

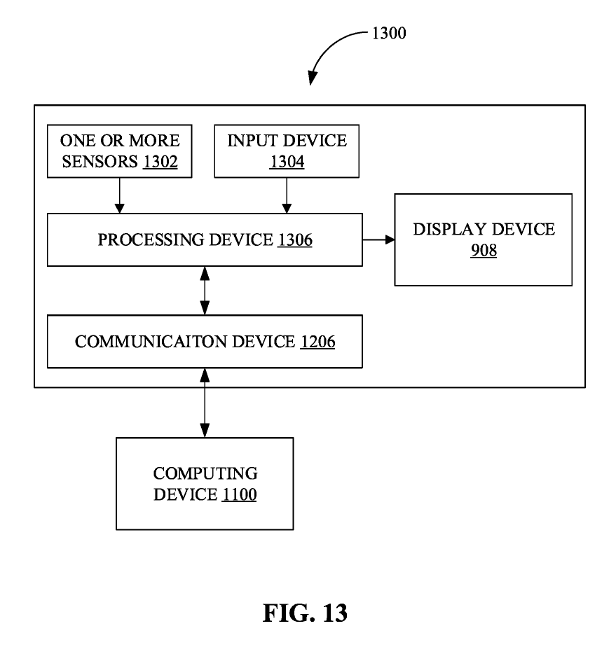

FIG. 13 illustrates a block diagram representation of a wearable display device 1300 that may be configured to provide a holographic projection content to a user in a way such that the holographic projection content may seem clear and/or focused to the user that may be having impaired eyes, in accordance with some embodiments. Accordingly, the wearable display device 1300, in an instance, may include, but not limited to, one or more sensors 1302, an input device 1304, a processing device 1306, the communication device 1206, and/or a display device 908. Further, the wearable display device 1300, in an instance, may be configured to detect an impairment data of the user in order to produce clear and/or focused holographic projection content. Further, the impairment data, in an instance, may be any data that may reflect a measure of degree of impairment and/or deficiency in an eyesight of the user. For instance, the impairment data may reflect an amount of refractive power (such as the refractive power of −2.5 diopters may be required by the user that may be suffering from Myopia.) that may be required by the user to see the holographic projection content clearly. Further, the user, in an instance, may provide the impairment data to the wearable display device 1300 through the input device 1304. The input device 1304, in an instance, may include, but not limited to, a keyboard, a touch-panel, a trackpad etc. through which the user may provide the impairment data. Further, the processing device 1306, in an instance, may be configured to analyze the impairment data of the user and/or may be configured to group a certain number of pixels of the display device 908 into a single unit that further may be controlled by the processing device 1306 in a way such that the holographic projection content on the display device 908 may seem defocused and/or blurry to the user with normal eyesight but may seem clear and/or focused to the user with impaired eyesight. Further, the certain number of pixels that may be grouped into the single unit by the processing device 1306, in an instance, may be decided based on a distance from an eye of the user to the display device 908, and/or may be based on the impairment data of the user. Further, the distance from the eye of the user to the display device 908, in an instance, may be determined by the processing device 1306 in real-time by analyzing a sensory data received from the one or more sensors 1302. Further, the sensory data, in an instance, may be any data that may be sensed by the one or more sensors 1302 and/or may reflect the distance when processed by the processing device 1306. Further, the one or more sensors 1302, in an instance, may include, but not limited to, proximity camera sensors, ultrasonic sensor, positions sensors, orientation sensors etc. For instance, the wearable display device 1300 may use the ultrasonic sensor that may be embedded within the wearable user device in order to measure the distance from the eye of the user to the visual display of the display device 908.

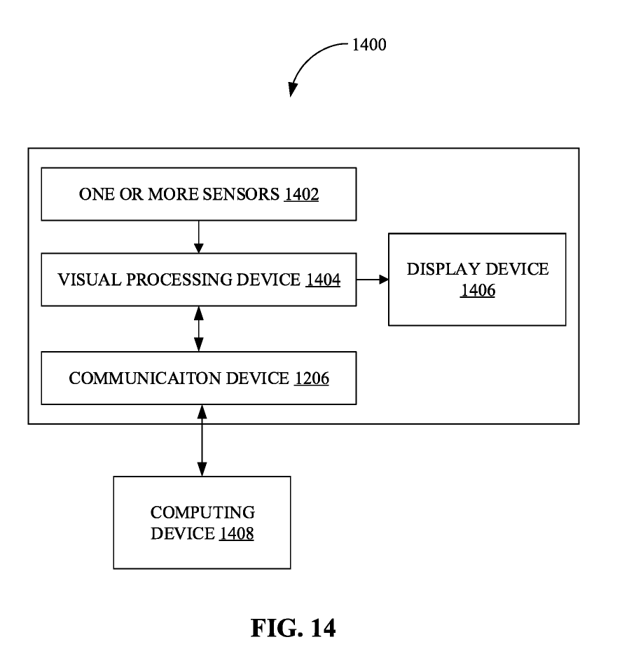

FIG. 14 illustrates a block diagram representation of a wearable display device 1400 that may be configured to adjust a visual parameter associated with a holographic projection content based on a surrounding of the wearable display device 1400, in accordance with some embodiments. Accordingly, the visual parameter associated with the holographic projection content, in an instance, may be any feature and/or characteristic of the holographic projection content that may affect and/or enhance a field of view of the user. The visual parameter, in an instance, may include, but not limited to, a brightness level, a color exposure, a contrast level, a saturation level etc. of the holographic projection content. Further, the wearable display device 1400, in an instance, may include, but not limited to, one or more sensors 1402, a visual processing device 1404, the communication device 1206, and/or a display device 1406. Further, the wearable display device 1400, in an instance, may be configured to sense a sensory data from the one or more sensors 1402. The sensory data, in an instance, may be any data that may be sensed by the one or more sensors 1402 and/or may reflect a visual feature (such as a luminous intensity and/or illuminance) from the surrounding of the wearable display device 1400. Further, the one or more sensors 1402, in an instance, may include, but not limited to, light sensors, lux meters, camera sensors etc. Further, the visual processing device 1404, in an instance, may be a processing device that may be configured to analyze the sensory data in order to determine the visual feature (such as the illuminance) from the surrounding of the wearable display device 1400. Further, the visual processing device 1404, in an instance, may carry out a computer program by performing arithmetic, logical, and/or control operations for determining the visual features from the surrounding of the wearable display device 1400. Further, the sensory data processed by the visual processing device 1404, in one embodiment, may be transmitted (through the communication device 1206) to a computing device 1408. The computing device 1408, in an instance, may be configured to generate the holographic projection content and/or may be configured to adjust the visual parameter (such as the brightness level) associated with the holographic projection content based on the visual feature of the surrounding determined by the visual processing device 1404 by using the sensory data. Further, the brightness level of the holographic projection content, in an instance, may be increased when a high magnitude of illuminance may be observed in the surrounding of the wearable user device (for instance, when the wearable display device 1400 may be used in an outdoor bright light condition, and/or may be used at noon time). Further, the brightness level of the holographic projection content, in an instance, may be reduced when a low magnitude of illuminance may be observed (by analyzing the sensory data through the visual processing device 1404) in the surrounding of the wearable user device (for instance, when the wearable display device 1400 may be used in an indoor low light condition, and/or may be used at evening and/or night time). Further, the computing device 1408, in an instance, may transmit the holographic projection content (with appropriate brightness level based on an ambient lighting) to the display device 1406 through the communication device 1206. Further, the display device 1406, in an instance, may be a device that may be configured to generate a visual display of the holographic projection content received from the computing device 1408. Further, in another embodiment, the sensory data processed by the visual processing device 1404, in an instance, may be transmitted directly to the display device 1406 that may be configured to adjust the brightness level of the visual display based on the visual feature of the surrounding determined by the visual processing device 1404 by using the sensory data. The brightness level of the visual display of the display device 1406, in an instance, may be increased when a high magnitude of illuminance may be observed in the surrounding of the wearable user device (for instance, when the wearable display device 1400 may be used in an outdoor bright light condition, and/or may be used at noon time). Further, the brightness level of the visual display of the display device 1406, in an instance, may be reduced when a low magnitude of illuminance may be observed (by analyzing the sensory data through the visual processing device 1404) in the surrounding of the wearable user device (for instance, when the wearable display device 1400 may be used in an indoor low light condition, and/or may be used at evening and/or night time).

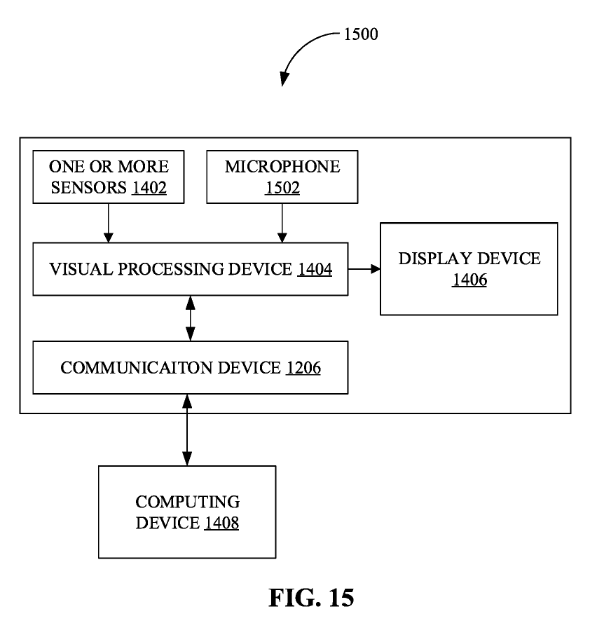

FIG. 15 illustrates a block diagram representation of a wearable display device 1500 that may be configured to adjust the visual parameter associated with the holographic projection content based on an indicating signal from a user, in accordance with some embodiments. Further, in some embodiments, the user may be able to adjust the visual parameter (such as the brightness level, color, exposure, contrast etc.) of the visual display of the display device 1406 by providing the indicating signal to the wearable display device 1500. The indicating signal, in an instance, may be a voice command from the user that may be sensed by a microphone 1502. The microphone 1502, in an instance, may be embedded and/or disposed within the wearable display device 1500. Further, the microphone 1502, in an instance, may collect the voice command from the user and/or may convert the voice command into a digital form that may be processed by the visual processing device 1404. Further, the voice command, in an instance, may include phrases such as, but not limited to, “increase exposure”, “decrease color saturation”, “visuals up”, “brightness up” etc. For instance, the user may provide the indicating signal by saying “brightness up” in order to increase the brightness level of the visual display of the display device 1406, whereas, the user may provide the indicating signal by saying “decrease color saturation” in order to decrease a color saturation level of the visual display of the display device 1406.

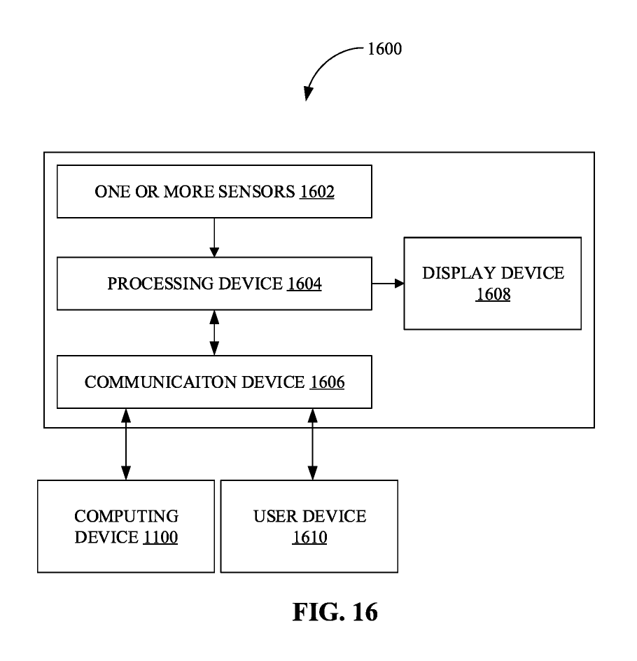

FIG. 16 illustrates a block diagram representation of a wearable display device 1600 that may be configured to allow a user to create a three-dimensional animation from a market user interface, in accordance with some embodiments. Further, the three-dimensional animation, in an instance, may be the holographic projection content that the user may wish to create that may further be added and/or removed in and/or from the field of view of the user. Further, the three-dimensional animation, in an instance, may be generated and/or downloaded from the market user interface (such as an app CARVE). Further, the market user interface, in one embodiment, may allow the user to create and/or download the three-dimensional animation through a user device 1610. Further, the user device 1610, in an instance, may be an IoT based device that may be configured to communicate with the wearable display device 1600 through a communication device 1606. Further, the user device 1610, in an instance, may provide an interface (such as a display screen) that may allow the user to create and/or download the three-dimensional animation. Further, the user device 1610, in an instance, may include, but not limited to, a smartphone, a smartwatch, a laptop, a PC, a desktop etc. Further, in another embodiment, the market user interface, in an instance, may allow the user to make and/or create the three-dimensional animation through a movement of one or more body part of the user that may be sensed by one or more sensors 1602 of the wearable display device 1600. For instance, the user may create a shape (such as a triangular shape) by moving the hands in a triangular form in an actual space.

Further, in some embodiments, the wearable display device 1600 may be an augmented reality-equipped glass with the one or more sensors 1602 embedded and/or disposed above lenses of the wearable display device 1600. Further, a display device 1608 of the wearable display device 1600, in an instance, may be a heads-up display (HUD) that may be configured to project the holographic projection content in a field of view of the user. Further, the display device 1608, in one embodiment, may be a transparent display that may act as a lens of the augmented reality-equipped glasses. Further, the one or more sensors 1602, in an instance, may be embedded and/or disposed above the lens of the wearable display device 1600 that may be configured to track a movement of one or more body parts of the user. Further, the one or more sensors 1602, in an instance, may include, but not limited to, camera sensors, motion sensors etc. For instance, the one or more sensors 1602 may be configured to track the movement of hands of the user. Further, a data that may be sensed by the one or more sensors 1602, in an instance, may be analyzed and/or processed by a processing device 1604 that may be configured to determine and/or track a position associated with the one or more body parts (such as hands) of the user. Further, the communication device 1606, in an instance, may be configured to transmit the data to the computing device 1100 that may be configured to generate the holographic projection content based on the determining and/or the tracking of the position associated with the one or more body parts of the user. Further, the communication device 1606, in some embodiments, may include a wired communication interface that may be communicatively coupled with the computing device 1100. Further, the wired communication interface, in an instance, may be of a size that may be accommodated within a frame of the augmented reality-equipped glasses. Further, the wired communication interface, in an instance, may include conductors (a wire on both sides in front of the user's ears to the computing device 1100) with high conductivity and/or low resistivity to transmit the data with minimum attenuation. Further, the conductors of the wired communication interface, in an instance, may be made up of materials such as, but not limited to, silver, copper, aluminum, and/or gold etc. Further, the holographic projection content generated and/or updated by the computing device 1100 based on the data from the one or more sensors 1602, in an instance, may be received by the display device 1608 through the communication device 1606.

In some embodiment, the wearable display device 1600 configured to facilitate provisioning of holographic content in cooperation with at least one computing device (such as the computing device 1100). Further, the wearable display device 1600 may include at least one sensor (such as the one or more sensors 1602) that may be configured to detect sensor data corresponding to one or more of a location and an orientation of the wearable display device 1600. Further, the wearable display device 1600 may include a communication interface (such as the communication device 1606) that may be configured to transmit the sensor data to the at least one computing device. Further, the communication interface may be configured to receive the holographic projection content from the at least one computing device. Further, the holographic projection content may be generated by the at least one computing device based on the sensor data and a geo-location. Further, the at least one computing device may include a geo-location sensor configured for detecting the geo-location. Further, the communication interface may be configured to receive audio content associated with the holographic projection content from the at least one computing device. Further, the wearable display device 1600 may include a processor (such as the processing device 1604) communicatively coupled to the communication interface. Further, the processor may be configured to process the holographic projection content. Further, the wearable display device 1600 may include the display device 1608 communicatively coupled to the processor. Further, the display device 1608 may be configured to generate a visual display of the holographic projection content. Further, the wearable display device 1600 may include at least one sound producing device configured for generating sound based on the audio content. Further, the at least one sound producing device, in an instance, may include device such as (but not limited to) a speaker. Further, the audio content, in an instance, may be any audible content associated with the holographic projection content. For instance, the audio content may include (but not limited to) audible phrases in a certain language (such as English) that may allow the user to verbally interact with the holographic projection content. Further, in another instance, the audio content may include (but not limited to) chime sound and/or an alert sound that may be used by the wearable display device 1600 to notify and/or alert the user. Further, the at least one sound producing device may be communicatively coupled to the processor.

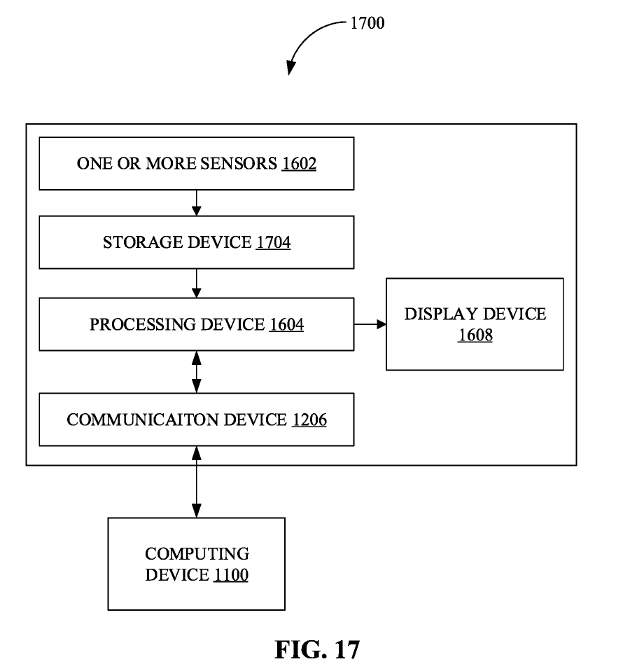

FIG. 17 illustrates a block diagram representation of the wearable display device 1700 that may be configured to allow a user to geo-drop a three-dimensional animation at a geo-location on a map, in accordance with some embodiments. Further, the geo-drop, in an instance, may be an act of placing a pin associated with the three-dimensional animation at the geo-location on the map. Further, the pin, in an instance, may be a marker representation on the map at the geo-location where the three-dimensional animation may be placed. Further, the map, in an instance, may be a representation of real world showing physical features, roads, cities etc. Further, the geo-location, in an instance, may be coordinates (longitudinal and/or latitudinal) of actual space that may represent a position and/or location of the pin on the map. Further, the three-dimensional animation at the geo-location, in an instance, may only be seen by the user that may be wearing the wearable display device 1700. Further, the three-dimensional animation, in an instance, may be the holographic projection content that may be created by the user using the market user interface. Further, the three-dimensional animation, in an instance, may be placed (and/or geo-dropped) at the geo-location by the user through the movement of the hands that may be tracked by one or more sensors 1602 (such as a camera sensor, a motion sensor etc.) of the wearable display device 1700. Further, the geo-location, in an instance, may be a location in the actual space where the user may wish to geo-drop the three-dimensional animation. Further, the user, in an instance, may be able to see the three-dimensional animation through the wearable display device 1700 at the geo-location from any perception view. Further, the user that may be present at the geo-location, in an instance, may be able to interact with the three-dimensional animation by using one or more gestures that may be tracked by the one or more sensors 1602 (such as a camera sensor, a motion sensor etc.) of the wearable display device 1700. Further, the wearable display device 1700, in an instance, may use a sensory data from a location and/or an orientation sensor in order to determine the location and/or orientation associated with the user that may be wearing the wearable display device 1700. Further, the sensory data from the location and/or the orientation sensor, and/or the geo-location of the three-dimensional animation, in an instance, may be analyzed by the computing device 1100 that may update the holographic projection content before transmitting to the display device 1608. Further, the geo-location where the three-dimensional animation may be placed, in an instance, may be stored in a storage device 1704. Further, the storage device 1704, in an instance, may be a storage space that may be configured to store the geo-location of the three-dimensional animation in a digital form.

In some embodiments, a communication interface (such as the communication device 1206) may be configured to receive an updated holographic projection content from at least one computing device (such as the computing device 1100). Further, the updated holographic projection content may be generated by the at least one computing device based on at least one gesture performed by at least one user. Further, the at least one computing device may include at least one gesture detection sensor configured to detect the at least one gesture. Further, the at least one computing device may be further configured to generate the updated holographic projection content based on the at least one gesture.

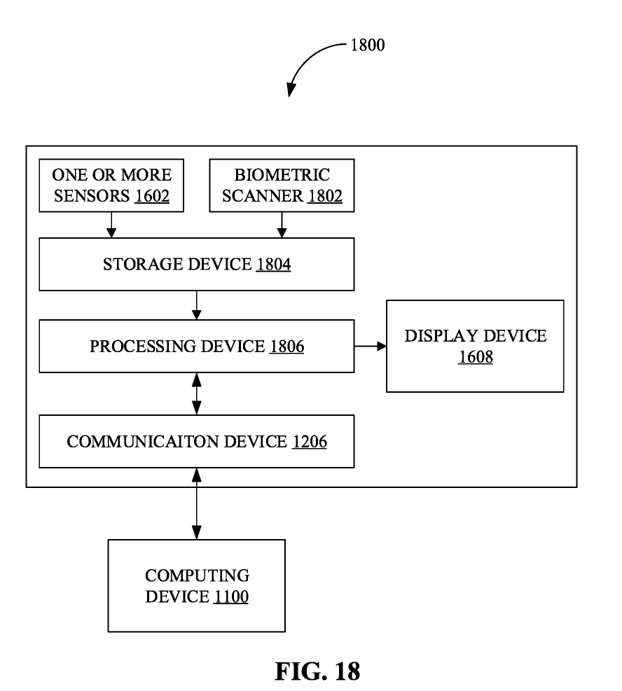

FIG. 18 illustrates a block diagram representation of a wearable display device 1800 that may be configured to allow only an authorized user to geo-drop the three-dimensional animation at the geo-location, in accordance with some embodiments. Accordingly, the three-dimensional animation, in an instance, may only be geo-dropped by the authorized user. The authorized user, in an instance, may any user that may have a permission to geo-drop the three-dimensional animation at the geo-location. Further, the wearable display device 1800, in an instance, may include a biometric scanner 1802 that may be configured to sense and/or scan a biometric data associated with the user. Further, the biometric data, in an instance, may be characterized as a distinct, measurable characteristic that may be embodied in an individual and/or may be used to label and/or describe an individual. For instance, the biometric data may include, but not limited to, fingerprint, palm veins, palm print, face recognition, DNA, hand geometry, iris recognition, retina, voice, odor/scent etc. Further, the biometric data associated with the authorized user, in an instance, may be stored in a storage device 1804. The storage device 1804, in an instance, may be a storage space that may be configured to store the biometric data associated with the authorized user. Further, the biometric data associated with the user, in an instance, may be analyzed by a processing device 1806 that may be configured to determine an identity of the user. The processing device 1806, in an instance, may compare the biometric data sensed by the biometric scanner 1802 with a biometric data of the authorized user that may be stored in the storage device 1804. Further, once an identity of the user may be determined to be the authorized user, the user may be allowed to geo-drop the three-dimensional animation at the geo-location. Further, the geo dropping of the three-dimensional animation, in an instance, may signify that the three-dimensional animation may be viewed by one or more users (with the wearable display device 1800) that may be present at the geo-location.

In some embodiments, the wearable display device 1800 may include an input device (such as the biometric scanner 1802) configured to receive authentication data. Further, a communication interface (such as the communication device 1206) may be configured to transmit the authentication data to at least one computing device (such as the computing device 1100). Further, the at least one computing device may be configured to authenticate the wearable display device based on the authentication data. Further, reception of the holographic projection content may be based on authentication of the wearable display device 1800. In some embodiments, the input device may include at least one biometric sensor (such as, but not limited to, fingerprint sensors, iris sensors etc.) configured to detect a biometric variable associated with at least one user. Further, the authentication data may include the biometric variable. Further, the biometric variable may include, but not limited to, fingerprint, palm veins, palm print, face recognition, DNA, hand geometry, iris recognition, retina, voice, odor/scent etc. associated with the at least one user.

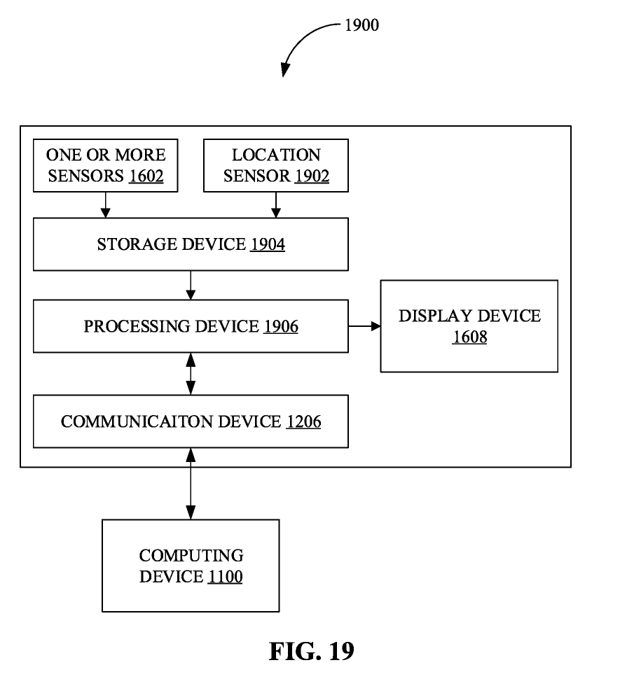

FIG. 19 illustrates a block diagram representation of a wearable display device 1900 that may be configured to allow the user to geo-drop the three-dimensional animation at the geo-location based on a location of the user, in accordance with some embodiments. Accordingly, in some embodiments, the three-dimensional animation, in an instance, may not be geo-dropped by the user at a plurality of restricted locations. The plurality of restricted locations, in an instance, may be one or more locations that may restrict the user to geo-drop the three-dimensional animation. For instance, the plurality of restricted locations may include, but not limited to, a private property, a militarized zone, a restricted area etc. Further, the wearable display device 1900, in an instance, may include a location sensor 1902. The location sensor 1902, in an instance, may be a GPS device that may be configured to sense a location data that may reflect a real-time location of the user. Further, the location data of the user, in an instance, may be analyzed by a processing device 1906 that may be configured to determine if the user may be present at the restricted location or not. Further, the processing device 1906, in an instance, may compare the real-time location (by using the location data from the location sensor) of the user with the plurality of restricted locations that may be stored in a storage device 1904. Further, the storage device 1904, in an instance, may be a storage space that may be configured to store the plurality of restricted locations in a digital form.

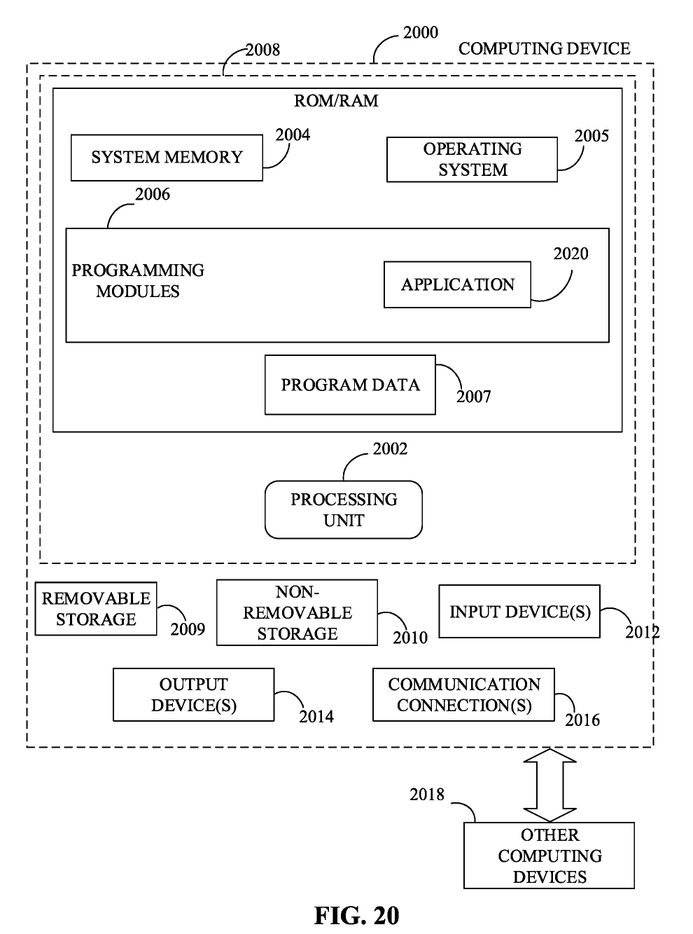

FIG. 20 is a block diagram of a system including computing device 2000. Consistent with an embodiment of the disclosure, the aforementioned memory storage and processing unit may be implemented in a computing device, such as computing device 2000 of FIG. 20. Any suitable combination of hardware, software, or firmware may be used to implement the memory storage and processing unit. For example, the memory storage and processing unit may be implemented with computing device 2000 or any of other computing devices 2018, in combination with computing device 2000. The aforementioned system, device, and processors are examples and other systems, devices, and processors may comprise the aforementioned memory storage and processing unit, consistent with embodiments of the disclosure.

With reference to FIG. 20, a system consistent with an embodiment of the disclosure may include a computing device or cloud service, such as computing device 2000. In a basic configuration, computing device 2000 may include at least one processing unit 2002 and a system memory 2004. Depending on the configuration and type of computing device, system memory 2004 may comprise, but is not limited to, volatile (e.g. random access memory (RAM)), non-volatile (e.g. read-only memory (ROM)), flash memory, or any combination. System memory 2004 may include operating system 2005, one or more programming modules 2006, and may include a program data 2007. Operating system 2005, for example, may be suitable for controlling computing device 2000's operation. Accordingly, in some embodiments, the programming modules 2006 may be implemented using one or more of software and hardware. For example, in an instance, the programming modules 2006 may be implemented as modules of a Digital Signal Processor (DSP). Further, in another instance, multiple types of completely DSP chip powered and/or analog physical hardware unit designs may be used. Further, the implementation of the programming modules could also be a combination of mostly DSP modules with some analog modules/processing as well. Further, in some embodiments, as long as the dithering module is implemented via a DSP chip, technically the rest of the modules may be analog modules. Accordingly, stress testing may be performed to determine which components would be best for each unit's physical size limitations.

Furthermore, embodiments of the disclosure may be practiced in conjunction with a graphics library, other operating systems, or any other application program and is not limited to any particular application or system. This basic configuration is illustrated in FIG. 20 by those components within a dashed line 2008.

Computing device 2000 may have additional features or functionality. For example, computing device 2000 may also include additional data storage devices (removable and/or non-removable) such as, for example, magnetic disks, optical disks, or tape. Such additional storage is illustrated in FIG. 20 by a removable storage 2009 and a non-removable storage 2010. Computer storage media may include volatile and nonvolatile, removable and non-removable media implemented in any method or technology for storage of information, such as computer-readable instructions, data structures, program modules, or other data. System memory 2004, removable storage 2009, and non-removable storage 2010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2000. Any such computer storage media may be part of device 2000. Computing device 2000 may also have input device(s) 2012 such as a keyboard, a mouse, a pen, a sound input device, a touch input device, etc. Output device(s) 2014 such as a display, speakers, a printer, etc. may also be included. The aforementioned devices are examples and others may be used.

Computing device 2000 may also contain a communication connection 2016 that may allow device 2000 to communicate with other computing devices 2018, such as over a network in a distributed computing environment, for example, an intranet or the Internet. Communication connection 2016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2004, including operating system 2005. While executing on processing unit 2002, programming modules 2006 (e.g., application 2020) may perform processes including, for example, one or more stages of methods, algorithms, systems, applications, servers, databases as described above. The aforementioned process is an example, and processing unit 2002 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A wearable display device configured to facilitate provisioning of holographic content in cooperation with at least one computing device, the wearable display device comprising:
at least one sensor configured to detect sensor data corresponding to at least one of a location and an orientation of the wearable display device, wherein the location comprises a geo-spatial location;
a communication interface configured to:
transmit the sensor data to the at least one computing device; and
receive holographic projection content from the at least one computing device, wherein the holographic projection content is generated by the at least one computing device based on the sensor data;
a processor communicatively coupled to the communication interface, wherein the processor is configured to process the holographic projection content; and
a display device communicatively coupled to the processor, wherein the display device is configured to generate a visual display of the holographic projection content.

2. The wearable display device of claim 1 further comprising at least one sound producing device configured for generating sound based on audio content associated with the holographic projection content, wherein the at least one sound producing device is communicatively coupled to the processor, wherein the communication interface is further configured to receive the audio content from the at least one computing device.

3. The wearable display device of claim 2, wherein the audio content is generated by the at least one computing device based on the sensor data.

4. The wearable display device of claim 2, wherein the audio content is generated by the at least one computing device based on the geo-spatial location.

5. The wearable display device of claim 1, wherein the at least one sensor is further configured to detect at least one contextual value of at least one contextual parameter, wherein the communication interface is further configured to transmit the at least one contextual value, wherein the holographic projection content generated by the at least one computing device is further based on the at least one contextual value.

6. The wearable display device of claim 5, wherein the at least one contextual parameter comprises at least one environmental characteristic and at least one user characteristic.

7. The wearable display device of claim 1 further comprising an input device configured to receive at least one user input, wherein the input device is communicatively coupled to at least one of the processor and the at least one computing device, wherein the at least one computing device is further configured to:
generate the holographic projection content based on a first user input; and
generate an association between the holographic projection content and the sensor data based on a second user input, wherein the at least one computing device comprises a storage device configured for storing the sensor data in association with the holographic projection content.

8. The wearable display device of claim 7, wherein the input device comprises at least one gesture detection sensor communicatively coupled to the processor, wherein the at least one gesture detection sensor is configured to detect gesture sensor data, wherein the processor is configured to detect least one gesture performed by at least one user based on the gesture sensor data, wherein the communication interface is further configured to:
transmit indication of the at least one gesture to the at least one computing device; and
receive an updated holographic projection content from the at least one computing device, wherein the updated holographic projection content is generated by the at least one computing device based on the indication of the at least one gesture.

9. The wearable display device of claim 8, wherein the at least one gesture comprises a first gesture corresponding to the first user input and a second gesture corresponding to the second user input, wherein the generation of the holographic projection content comprises modification of the holographic projection content based on the first gesture.

10. The wearable display device of claim 8, wherein the at least one gesture further comprises a third gesture configured to function as a trigger, wherein the storage device is further configured for storing indication of the third gesture in association with the holographic projection content and the sensor data.

11. The wearable display device of claim 1, wherein the at least one sensor comprises a geo-location sensor configured for detecting the geo-spatial location.

12. The wearable display device of claim 1 further comprising at least one optical marker configured to facilitate determination of at least one of the location and the orientation, wherein the location comprises at least one relative location of the wearable device with respect to the at least one computing device, wherein the at least one computing device is configured to perform the determination based on at least one image of the at least one optical marker.

13. The wearable display device of claim 1 further comprising a camera communicatively coupled to the processor, wherein the camera is configured to capture at least one holotag, wherein the processor is configured to analyze the at least one holotag, wherein the communication interface is configured to establish a communication session with the at least one computing device based on the analysis of the at least one holotag, wherein the communication session comprises at least one of transmission of the sensor data and reception of the holographic projection content.

14. The wearable display device of claim 1 further comprising an input device configured to receive authentication data, wherein the communication interface is further configured to transmit the authentication data to the at least one computing device, wherein the at least one computing device is configured to authenticate the wearable display device based on the authentication data, wherein reception of the holographic projection content is based on authentication of the wearable display device.

15. The wearable display device of claim 14, wherein the input device comprises at least one biometric sensor configured to detect a biometric variable associated with at least one user, wherein the authentication data comprises the biometric variable.

16. The wearable display device of claim 13, wherein the at least one holotag is rendered on at least one display of the at least one computing device, wherein the holographic projection content is anchored to the at least one holotag.

17. The wearable display device of claim 13, wherein the at least one holotag is imprinted on a physical object, wherein the communication interface is further configured to transmit the at least one holotag to the at least one computing device.

18. The wearable display device of claim 8, wherein the processor is configured to determine a spatial correlation between the at least one gesture and the holographic projection content, wherein the processor is further configured to detect the at least one gesture further based on the spatial correlation.

19. The wearable display device of claim 1, wherein the communication interface is further configured to receive an updated holographic projection content from the at least one computing device, wherein the updated holographic projection content is generated by the at least one computing device based on at least one gesture performed by at least one user, wherein the at least one computing device comprises at least one gesture detection sensor configured to detect the at least one gesture, wherein the at least computing device is further configured to generate the updated holographic projection content based on the at least one gesture.

20. A wearable display device configured to facilitate provisioning of holographic content in cooperation with at least one computing device, the wearable display device comprising:
at least one sensor configured to detect sensor data corresponding to at least one of a location and an orientation of the wearable display device;
a communication interface configured to:
transmit the sensor data to the at least one computing device;
receive holographic projection content from the at least one computing device, wherein the holographic projection content is generated by the at least one computing device based on the sensor data and a geo-location, wherein the at least one computing device comprises a geo-location sensor configured for detecting the geo-location; and
receive audio content associated with the holographic projection content from the at least one computing device;
a processor communicatively coupled to the communication interface, wherein the processor is configured to process the holographic projection content;
a display device communicatively coupled to the processor, wherein the display device is configured to generate a visual display of the holographic projection content; and
at least one sound producing device configured for generating sound based on the audio content, wherein the at least one sound producing device is communicatively coupled to the processor.
